(19) United States
(12) Patent Application Publication
(10) Pub. No.: US 2018/0330229 A1
(43) Pub. Date: Nov. 15, 2018

(54) INFORMATION PROCESSING APPARATUS, METHOD AND NON-TRANSITORY COMPUTER-READABLE STORAGE MEDIUM

(71) Applicant: FUJITSU LIMITED, Kawasaki-shi (JP)

(72) Inventor: Koichi Shirahata, Yokohama (JP)

(73) Assignee: FUJITSU LIMITED, Kawasaki-shi (JP)

(21) Appl. No.: 15/966,363

(22) Filed: Apr. 30, 2018

(30) Foreign Application Priority Data
May 15, 2017 (JP) 2017-096814

(51) Int. Cl. G06N 3/063; G06N 3/08

(52) U.S. Cl. CPC G06N 3/063; G06N 3/084

(57) ABSTRACT

An information processing apparatus includes a memory and a processor coupled to the memory and configured to set a first memory region in the memory as a region to be used for input to a first intermediate layer of a layered neural network and for output from the first intermediate layer, set a second memory region in the memory as a buffer region for the first intermediate layer, execute a recognition process of storing, in the second memory region, characteristic data corresponding to a characteristic of an input neuron data item to the first intermediate layer, and execute a learning process of determining an error of the first intermediate layer using the characteristic data stored in the second memory region.

### CROSS-REFERENCE TO RELATED APPLICATION

This application is based upon and claims the benefit of priority of the prior Japanese Patent Application No. 2017-96814, filed on May 15, 2017, the entire contents of which are incorporated herein by reference.

### FIELD

The embodiments discussed herein are related to an information processing apparatus, an information processing system, a method and a non-transitory computer-readable storage medium.

### BACKGROUND

In recent years, machine learning using a neural network with a multi-layered structure has been paid attention. The machine learning using the neural network with the multi-layered structure is also referred to deep learning. The multi-layering of neural networks has been progressed for deep learning, and the effectiveness of deep learning has been confirmed in various fields. For example, the accuracy of recognizing images and audio in deep learning is almost as high as that of human beings. As related-art documents, there are Japanese Laid-open Patent Publication No. 2008-310524, Japanese Laid-open Patent Publication No. 2009-80693, and Japanese Laid-open Patent Publication No. 2008-310700.

### SUMMARY

According to an aspect of the invention, an information processing apparatus includes a memory and a processor coupled to the memory and configured to set a first memory region in the memory as a region to be used for input to a first intermediate layer of a layered neural network and for output from the first intermediate layer, set a second memory region in the memory as a buffer region for the first intermediate layer, execute a recognition process of storing, in the second memory region, characteristic data corresponding to a characteristic of an input neuron data item to the first intermediate layer, and execute a learning process of determining an error of the first intermediate layer using the characteristic data stored in the second memory region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating an example of the flow of a deep learning process;

FIG. 2A is a diagram schematically illustrating an example of a convolution operation;

FIG. 2B is a diagram schematically illustrating an example (ReLU) of an activation function;

FIG. 2C is a diagram schematically illustrating an example of decimation;

FIG. 2D is a diagram schematically illustrating an example of full connection;

FIG. 3 is a diagram illustrating an example of the flow of calculation of a neural network including intermediate layers that execute an in-place process;

FIG. 4 is a diagram illustrating an example of a functional configuration of an information processing apparatus according to a first embodiment;

FIG. 5 is a diagram illustrating relationships between an activation function and characteristic data according to the first embodiment;

FIG. 6 is a diagram illustrating relationships between an input string, an output string, and a characteristic data string according to the first embodiment;

FIG. 7 is a diagram illustrating an example of the flow of calculation of the neural network according to the first embodiment;

FIGS. 8A, 8B, and 8C are flowcharts illustrating an example of an information processing method according to the first embodiment;

FIG. 9 is a diagram illustrating an example of the flow of calculation of a neural network according to a second embodiment;

FIGS. 10A, 10B, and 10C are flowcharts illustrating an example of an information processing method according to the second embodiment;

FIG. 11 is a diagram illustrating an example of calculation of a neural network according to a third embodiment;

FIGS. 12A, 12B and 12C are flowcharts illustrating an example of an information processing method according to the third embodiment; and

FIG. 13 is a diagram illustrating an example of the configuration of a computer that executes an information processing program.

### DESCRIPTION OF EMBODIMENTS

In deep learning, supervised learning is executed to cause a neural network to automatically learn characteristics. In deep learning, however, a memory amount to be used is large due to the multi-layering of the neural network and is further increased upon the learning. For example, in backpropagation generally used for supervised learning, data for learning is propagated forward by the neural network, recognition is executed, and an error is calculated by comparing the result of the recognition with correct data. Then, in backpropagation, the error between the result of the recognition and the correct data is propagated by the neural network in a direction opposite to that upon the recognition, and parameters of layers of the neural network are changed. Thus, upon the learning, the memory amount to be used increases. For example, since error gradients are stored in the learning, the amount of data may increase more than twofold, compared with that upon only the recognition, and the memory amount to be used may increase more than twofold.

Hereinafter, embodiments of an information processing apparatus, an information processing system, an information processing program, and an information processing method, which are disclosed herein, are described in detail based on the accompanying drawings. The techniques disclosed herein are not limited by the embodiments. The embodiments described below may be combined without contradiction.

### First Embodiment

[Description of Deep Learning]

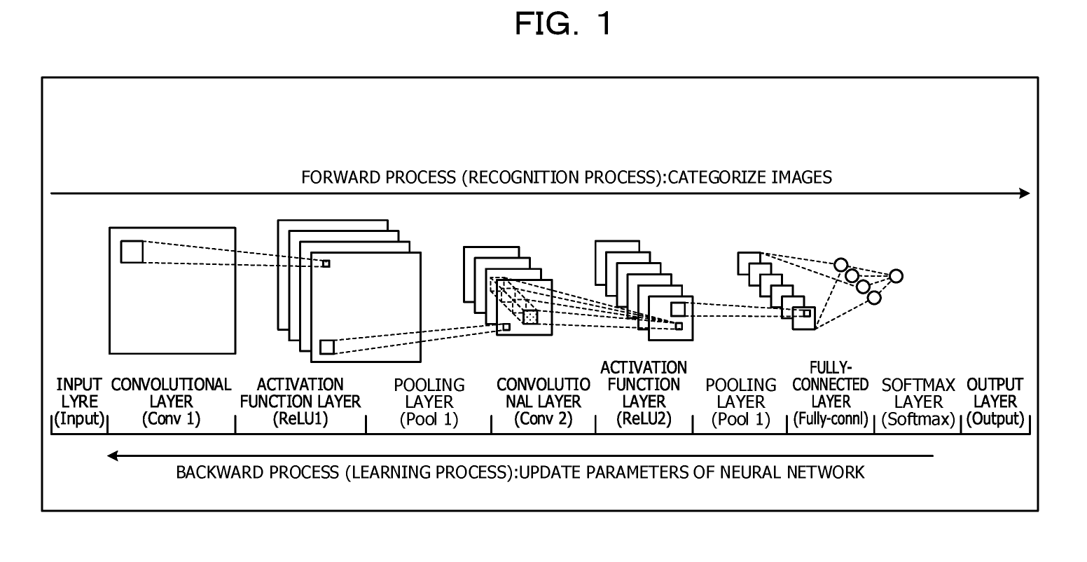

Deep learning is described. FIG. 1 is a diagram schematically illustrating an example of the flow of a deep learning process.

In deep learning, supervised learning is executed on a target to be identified to cause a neural network to automatically learn characteristics of the target to be identified. In deep learning, the target to be identified is identified using the neural network that has learned the characteristics. For example, in deep learning, supervised learning is executed on a large number of images serving as images for learning and including the target to be identified to cause the neural network to automatically learn characteristics of the target to be identified and included in the images. In deep learning, by using the neural network that has learned the characteristics, the target to be identified and included in the images may be identified.

In a brain, a large number of neurons (nerve cells) exist. Each neuron receives signals from other neurons and transfers signals to other neurons. The brain executes various information processes in accordance with the signal flows. The neural network is a model obtained by achieving characteristics of such a brain function in a computer. In the neural network, units that simulate such brain neurons are hierarchically combined. The units are also referred to as nodes. Each unit receives data from another unit, applies a parameter (weight) to the data, and transfers the data to another unit. The neural network may change parameters of the units based on learning and change data to be transferred, thereby identifying (recognizing) various targets to be identified. Hereinafter, data to be transferred in a neural network is referred to as neuron data item.

FIG. 1 illustrates, as an example of a neural network, an example of a convolutional neural network (CNN) to be used to recognize an image. The case where an image is recognized by the convolutional neural network as the neural network is described below as an example.

The neural network is a layered neural network having a layered structure and may include multiple intermediate layers between an input layer and an output layer. The multiple intermediate layers include, for example, convolutional layers, activation function layers, pooling layers, a fully-connected layer, and a softmax layer. The number of layers and the positions of the layers are not limited to those exemplified in FIG. 1 and may be changed based on requested architecture. Specifically, the layered structure of the neural network and the configuration of the layers may be defined by a designer based on a target to be identified.

In the neural network, in the case where an image is to be identified, characteristics of a target to be identified and included in the image are extracted by executing processes of the intermediate layers from the left side to the right side as illustrated in FIG. 1, and the identification (categorization) of the target to be identified and included in the image is lastly executed by the output layer. This process is referred to as forward process or recognition process. On the other hand, in the neural network, in the case where the image is learned, an error between the identified result and correct data is calculated, the neural network propagates the error backward from the right side to the left side as illustrated in FIG. 1 and changes parameters (weights) of the intermediate layers. This process is referred to as backward process or learning process.

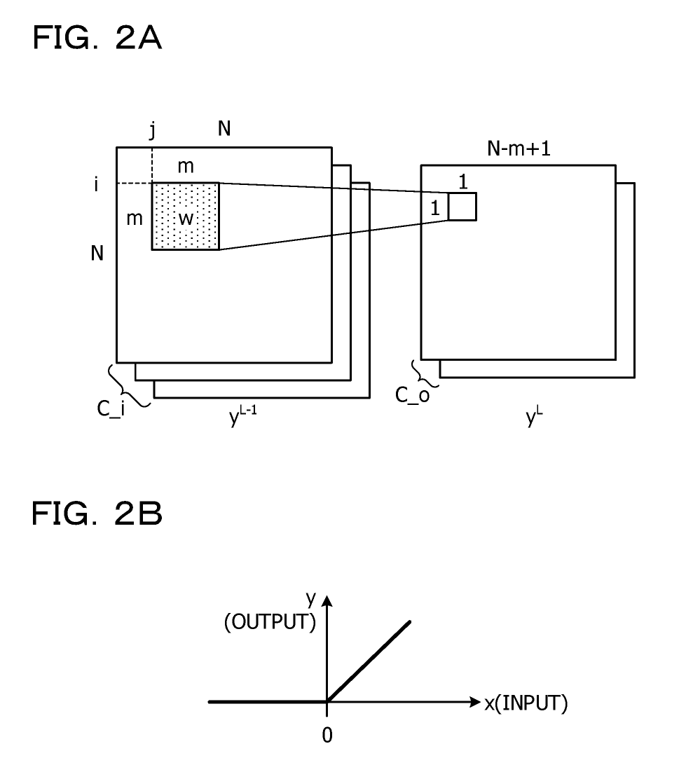

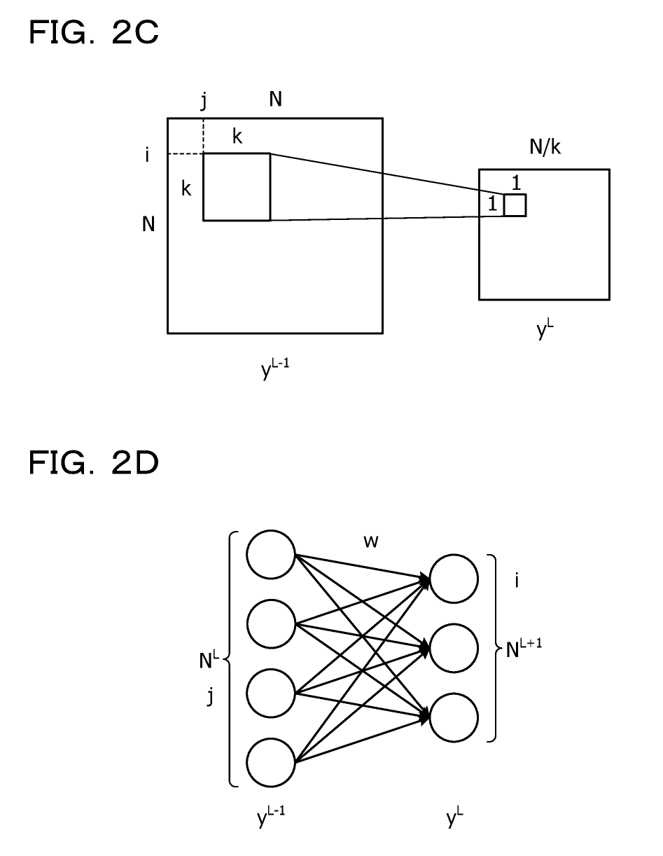

Next, operations of the intermediate layers are described. In each of the convolutional layers, a convolution operation (convolution process) is executed on input neuron data items. FIG. 2A is a diagram schematically illustrating an example of the convolution operation. The example illustrated in FIG. 2A indicates that the convolution operation is executed on input images of N×N pixels. In each of the convolutional layers, neuron data items for output to the next layer are generated by using, as neuron data items, values of pixels of the images each having N×N pixels to execute the convolution operation with a filter that has an m×m size and in which parameters are set.

In the activation function layers, the characteristics extracted in the convolutional layers are highlighted. Specifically, in the activation function layers, activation is modeled by causing the neuron data items for output to pass through an activation function σ. The activation is an effect in which a signal output when the value of a signal output from a neuron exceeds a certain value is transmitted to another neuron.

For example, in the convolutional layers (Conv1 and Conv2), a convolution operation expressed by the following Equation (1) is executed. In the activation function layers (ReLU1 and ReLU2), an operation expressed by the following Equation (2) is executed on the results of the convolution operation using the activation function σ.

$$\begin{matrix}[ First and Second Equations ] & \\ {x}_{ij}^{L} = {\sum }_{a = 0}^{m - 1} {\sum }_{b = 0}^{m - 1} {w}_{ab} {y}_{( i + a ) ( j + b )}^{L - 1} & ( 1 ) \\ {y}_{ij}^{L} = σ ( {x}_{ij}^{L} ) + {b}^{L} & ( 2 )\end{matrix}$$

In this case, y^{L-1}_{(i+a)(j+b)} is an input neuron data item and is data of a pixel (i+a)(j+b) of an image (layer L−1) y^{L-1} of N×N pixels illustrated in FIG. 2A, w_{ab} is each parameter indicating a weight of the m×m filter w illustrated in FIG. 2A, x^{L}ᵢⱼ is data of a pixel (i, j) subjected to the convolution operation, and y^{L}ᵢⱼ is a neuron data item that is obtained by applying the activation function σ x^{L}ᵢⱼ to and adding a predetermined bias b^{L} to the result of the application and serves as output of a unit U^{L}i (layer L) and serves as input of the next layer L+1.

As the activation function σ used in the activation function layers (ReLU1 and ReLU2), a nonlinear activation function, for example, a rectified linear unit (ReLU) (or a ramp function) may be used. FIG. 2B is a diagram schematically illustrating an example (ReLU) of the activation function σ. In the example illustrated in FIG. 2B, if input x is lower than 0, 0 is output as output y. In addition, if the input x exceeds 0, the value of the input x is output as the output y.

In the pooling layers, decimation is executed on input neuron data items. FIG. 2C is a diagram schematically illustrating an example of the decimation. For example, an image of N×N pixels is input as neuron data items. In the pooling layers, the neuron data items of the N×N pixels are decimated to neuron data items of (N/k)×(N/k) pixels. For example, the decimation is executed by executing Max-Pooling to extract the maximum value for each region of k×k pixels. The decimation may be executed using another method. For example, the decimation may be executed by executing Average-Pooling to extract averages of the regions of k×k pixels. In addition, in the pooling layers, parts of the regions of k×k pixels to be decimated may overlap each other, or adjacent regions of k×k pixels may be decimated without overlapping each other.

For example, in the pooling layers (Pool1 and Pool2), Max-Pooling expressed by the following Equation (3) is executed.

[Third Equation]

y^{L}_{i,j}=max({y_{i+a,j+b}^{L-1}|a,bϵ[0,k−1]}) (3)

In this case, a function max is a function of outputting a neuron data item of the maximum value within a region of k×k pixels from a pixel (i, j) illustrated in FIG. 2C. y^{L}_{i,j} is a neuron data item as output of a unit U^{L}i.

In the fully-connected layer, extracted characteristics are connected and a variable indicating the characteristics is generated. Specifically, in the fully-connected layer, a full-connection operation is executed to fully connect input neuron data items. For example, an image of N×N pixels is input as neuron data items. The fully-connected layer multiplies all neuron data items of the N×N pixels by weights (parameters), thereby generating neuron data items for output to the next layer.

The softmax layer converts the variable generated in the fully-connected layer to a probability. Specifically, activation is modeled by executing an operation of causing the neuron data items for output to pass through an activation function σ such as a normalization function.

FIG. 2D is a diagram schematically illustrating an example of the full connection. The example illustrated in FIG. 2D indicates an example of the case where the number of targets to be identified is i and a number i of neuron data items are obtained by fully connecting a number j of neuron data items. For example, a full-connection operation expressed by the following Equation (4) is executed in the fully-connected layer (Fully-conn1), and an operation expressed by the following Equation (5) is executed on the result of the full-connection operation in the softmax layer (Softmax).

$$\begin{matrix}[ Fourth and Fifth Equations ] & \\ {x}_{i}^{L} = {\sum }_{j} {w}_{ji}^{L - 1} {y}_{j}^{L - 1} & ( 4 ) \\ {y}_{i}^{L} = σ ( {x}_{i}^{L} ) + {b}_{i}^{L} & ( 5 )\end{matrix}$$

In this case, y^{L-1}ⱼ is a neuron data item serving as output of a unit U^{L-1} and serving as input of a unit U^{L}. w^{L-1}ⱼᵢ is a parameter indicating a weight corresponding to y^{L-1}ⱼ and y^{L}ᵢ. x^{L}ᵢ is data subjected to a weighting operation. y^{L}ᵢ is a neuron data item that is obtained by applying the activation function σ to x^{L}ᵢ and adding a predetermined bias b^{L}ᵢ to the result of the application and serves as output of the unit U^{L}i.

As the activation function σ used in the softmax layer (Softmax), a nonlinear activation function, for example, a softmax function may be used. Neuron data items of the results of the operations by the neural network are actual numbers. The softmax layer normalizes the neuron data items of the results of the operation to easily identify the results.

For example, the softmax layer (Softmax) uses the activation function such as the softmax function to normalize the neuron data items of the operation results to values in a range of 0 to 1. The softmax function is obtained by generalizing a logistic function and normalizes an n-th dimensional vector x having an arbitrary actual number to an n-th dimensional vector σ(x) that causes the sum of actual numbers between 0 to 1 to be 1. For example, in the output layer, an operation of a softmax function expressed by the following Equation (6) is executed.

$$\begin{matrix}[ Sixth Equation ] & \\ σ ( {x}_{i} ) = \frac{exp ( {x}_{i} )}{{\sum }_{i = 1}^{n} exp ( {x}_{j} )} & ( 6 )\end{matrix}$$

Thus, a number n of neuron data items xᵢ of the results of the operations by the neural network are converted to a probability distribution of probabilities σ(x) that are targets i to be recognized. The neuron data items of the results of the operation by the softmax layer (Softmax) are output to the output layer and identified by the output layer.

For example, in the case where a target to be identified and included in an image is identified as any of 10 types, 10 neuron data items are output as operation results from the fully-connected layer to the softmax layer to the output layer. The output layer treats, as an identification result, the type of an image corresponding to neuron data items whose probability distribution is the largest. In addition, in the case where learning is executed, the output layer compares the identification result with correct data and calculates an error between the identification result and the correct data. For example, the output layer uses a cross-entropy error function to calculate an error between the identification result and a target probability distribution (correct data). For example, the output layer executes an operation of an error function expressed by the following Equation (7).

[Seventh Equation]

E=−Σᵢ₌₁ⁿtᵢ log(yᵢ) (7)

In this case, tᵢ is the target distribution. If the target i to be recognized is correct, tᵢ is 1. If the target i to be recognized is not correct, tᵢ is 0. yᵢ is a probability σ(xᵢ), calculated by the neural network, of the target i to be recognized.

In deep learning, supervised learning is executed to cause the neural network to automatically learn characteristics. For example, in backpropagation generally used for supervised learning, data for learning is propagated forward by the neural network, recognition is executed, and an error between the result of the recognition and correct data is calculated by comparing the result of the recognition with the correct data. Then, in backpropagation, the error between the result of the recognition and the correct data is propagated by the neural network in a direction opposite to that upon the recognition, and the parameters of the layers of the neural network are changed to approximate the result of the recognition to the correct data.

Next, an example of the calculation of the error is described. For example, in backpropagation, as the neuron data item error upon the recognition, a partial differential operation of an error function expressed by the following Equation (8) is executed.

$$\begin{matrix}[ Eighth Equation ] & \\ \frac{\partial E}{\partial {x}_{i}^{L}} = {y}_{i} - {t}_{i} & ( 8 )\end{matrix}$$

In backpropagation, a gradient of an error with respect to a parameter of the output layer (Output) is calculated from the following Equation (9). In the softmax layer (Softmax) for executing the operation using the softmax function, the result of Equation (8) is the error gradient of Equation (9).

$$\begin{matrix}[ Ninth Equation ] & \\ \frac{\partial E}{\partial {x}_{i}^{L}} = {σ}^{′} ( {x}_{i}^{L} ) \frac{\partial E}{\partial {y}_{i}^{L}} & ( 9 )\end{matrix}$$

In addition, in backpropagation, a gradient of an error with respect to input is calculated using a partial differential from an error in the output layer (Output). For example, in the activation function layers (ReLU1 and ReLU2) for executing the operation using the activation function such as ReLU, a gradient of an error with respect to input is calculated from the following Equation (10-1). σ′(x) is obtained by differentiating σ(x) with respect to x and calculated from the following Equation (10-2). A value used upon the recognition is used as x. The error gradient (∂E/∂x^{L}ᵢ) is calculated by substituting σ′(x) into Equation (10-1).

$$\begin{matrix}[ Tenth \text{-} 1 and Tenth \text{-} 2 Equations ] & \\ \frac{\partial E}{\partial {x}_{j}^{L}} = {σ}^{′} ( {x}_{j}^{L} ) \frac{\partial E}{\partial {y}_{j}^{L}} & ( 10 \text{-} 1 ) \\ {σ}^{′} ( x ) = \{ \begin{matrix}0 & ( x \leq 0 ) \\ 1 & ( otherwise )\end{matrix} & ( 10 \text{-} 2 )\end{matrix}$$

In addition, in backpropagation, in a layer having a parameter (weight) for an operation, a gradient of an error with respect to the parameter is calculated. For example, in the full-connection operation expressed by Equation (4), a gradient of an error with respect to a parameter is calculated from the following Equation (11-1). In addition, in the convolution operation expressed by Equation (1), a gradient of an error with respect to a parameter is calculated from the following Equation (11-2). A value used upon the recognition is used as obtained by using the partial differential chain rule.

$$\begin{matrix}[ Eleventh \text{-} 1 and Eleventh \text{-} 2 Equations ] & \\ \frac{\partial E}{\partial {w}_{ij}^{L}} = {y}_{i}^{L} \frac{\partial E}{\partial {x}_{j}^{L + 1}} & ( 11 \text{-} 1 ) \\ \frac{\partial E}{\partial {w}_{ab}} = {\sum }_{i = 0}^{N - m} {\sum }_{j = 0}^{N - m} \frac{\partial E}{\partial {x}_{ij}^{L}} \frac{\partial {x}_{ij}^{L}}{\partial {w}_{ab}} = {\sum }_{i = 0}^{N - m} {\sum }_{j = 0}^{N - m} \frac{\partial E}{\partial {x}_{ij}^{L}} {y}_{( i + a ) ( j + b )}^{L - 1} & ( 11 \text{-} 2 )\end{matrix}$$

In addition, in backpropagation, an error gradient to a preceding layer (L−1) layer is calculated. For example, if the preceding layer executes the full-connection operation, the error gradient to the preceding layer is calculated from the following Equation (12-1). In addition, if the preceding layer executes the convolution operation, the error gradient to the preceding layer is calculated from the following Equation (12-2). A value used upon the recognition is used as obtained by executing calculation using the partial differential chain rule. In addition, if the preceding layer is a pooling layer (Pool1 or Pool2) for executing Max-Pooling, the error gradient (∂E/∂x^{L}ᵢ) is added to a position from which the maximum value of a region of k×k pixels has been acquired upon the recognition. Any operation is not executed on other positions within the region of k×k pixels.

$$\begin{matrix}[ Twelfth \text{-} 1 and Twelfth \text{-} 2 Equations ] & \\ \frac{\partial E}{\partial {y}_{i}^{L}} = \sum {w}_{ij}^{L} \frac{\partial E}{\partial {x}_{j}^{L + 1}} & ( 12 \text{-} 1 ) \\ \begin{matrix}\frac{\partial E}{\partial {y}_{ij}^{L - 1}} = {\sum }_{a = 0}^{m - 1} {\sum }_{b = 0}^{m - 1} \frac{\partial E}{\partial {x}_{( i - a ) ( j - b )}^{L}} \frac{\partial {x}_{( i - a ) ( j - b )}^{L}}{\partial {y}_{ij}^{L - 1}} \\ = {\sum }_{a = 0}^{m - 1} {\sum }_{b = 0}^{m - 1} \frac{\partial E}{\partial {x}_{( i - a ) ( j - b )}^{L}} {w}_{ab}\end{matrix} & ( 12 \text{-} 2 )\end{matrix}$$

In the calculation of an error, backpropagation is executed by the neural network, and the calculation of an error gradient is repeated in each of the intermediate layers until the error reaches the input layer (Input) that is the highest-level layer of the neural network. For example, a gradient of an error with respect to input is calculated from an error in the output layer (Output) using Equation (10-1). For example, if a lower-level layer is the output layer, the input error gradient expressed by Equation (10-1) is calculated by substituting the error gradient expressed by Equation (9). If the lower-level layer is a layer other than the output layer, the input error gradient expressed by Equation (10-1) is calculated by substituting an error gradient calculated from Equation (12-1) or (12-2). For example, the parameter's error gradient expressed by Equation (11-1) is calculated by substituting the error gradient calculated from Equation (10-1). In addition, for example, the error gradient expressed by Equation (12-1) to the preceding layer is calculated by substituting the error gradient calculated from Equation (10-1). Then, in the calculation of the error, the parameters of all the layers are updated based on the error.

The neural network is used for the image recognition exemplified in FIGS. 1 and 2A to 2D and may be applied to various recognition processes such as audio recognition and language recognition. To improve the accuracy of this recognition process, the number of layers of the neural network may be increased and the size of the neural network may be increased. If the size of the neural network is increased, the amount of calculation to be executed in deep learning easily becomes large, but the process may be executed at a high speed by causing an accelerator (accelerator board) such as a graphics processing unit (GPU) or a dedicated chip to execute the operations. In this case, if the accelerator (accelerator board) is connected to a host (motherboard) so that the accelerator (accelerator board) is able to communicate with the host (motherboard), and deep learning is executed using a memory (host memory) on the host, the speed of the process is limited due to a data transfer rate of a communication path. Since a data transfer rate between the accelerator and the host is lower than a data transfer rate within the accelerator, the speed of the process may be increased by executing the process in a local memory within the accelerator.

To obtain high performance, power to be consumed by the local memory within the accelerator and a chip area for the local memory within the accelerator are limited. Specifically, the storage capacity of the local memory within the accelerator is limited, compared with the storage capacity of the host memory. For example, the storage capacity of the host memory is hundreds of gigabytes, the storage capacity of the local memory within the accelerator is 16 GB, and an available neural network size is limited.

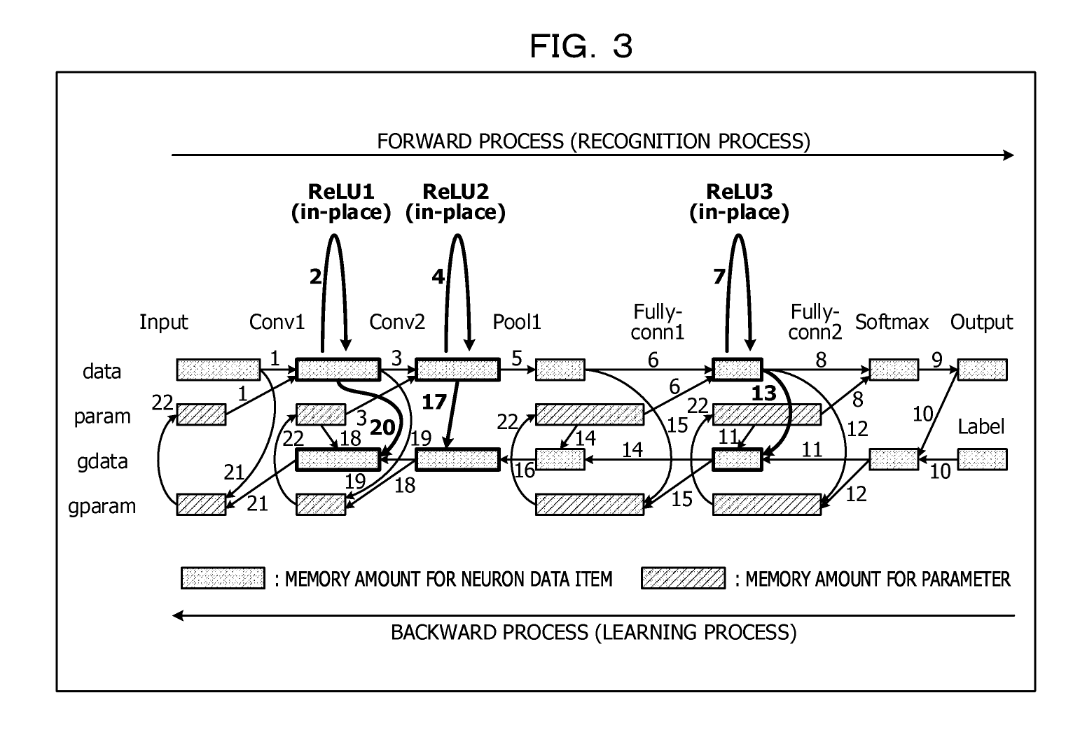

On the other hand, by executing the in-place process in a part of the intermediate layers of the neural network, a memory amount to be used may be reduced to some extent. In the in-place process, each of the intermediate layers is configured so that the same memory region is shared for input and output of the intermediate layer. In other words, in the in-place process, the same memory region is assigned to input and output of each intermediate layer. In the assigned memory region, an output neuron data item may be written over an input neuron data item to the intermediate layer. For example, the neural network may be configured as illustrated in FIG. 3. FIG. 3 is a diagram illustrating an example of the flow of calculation of the neural network including intermediate layers that execute the in-place process.

The example illustrated in FIG. 3 indicates data and the order of processes in the case where the learning of the convolutional neural network as the neural network is executed. The neural network has a layered structure in which layers are arranged in order. The neural network includes an input layer (Input), a first convolutional layer (Conv1), a first activation function layer (ReLU1), a second convolutional layer (Conv2), a second activation function layer (ReLU2), a first pooling layer (Pool1), a first fully-connected layer (Fully-conn1), and a third activation function layer (ReLU3) in this order. The neural network further includes a second fully-connected layer (Fully-conn2), a softmax layer (Softmax), and an output layer (Output) in this order. FIG. 3 exemplifies the case where the intermediate layers that execute the in-place process are the activation function layers (ReLU1, ReLU2, and ReLU3).

In FIG. 3, “data” indicates the data size of a neuron data item of each of the layers, “param” indicates the data size of a parameter of each of the layers, “gdata” indicates the data size of a gradient of an error with respect to a neuron data item of each of the layers, and “gparam” indicates the data size of a gradient of an error with respect to a parameter of each of the layers. Arrows indicate the flow of a process to be executed upon the learning of the neural network. Numbers added to the arrows indicate the order of processes.

In the case where the learning of the neural network is executed, the recognition process is executed and the learning process is executed after the recognition process. In the recognition process, a process of identifying an image of a target to be learned is executed. Specifically, in the recognition process, processes of the layers are executed in order from a number “1” to a number “9” on the image of the target to be learned, and the result of the processes is output.

For example, as indicated by the number “1”, the convolution operation is executed by the first convolutional layer (Conv1) on neuron data items received from the input layer (Input), a parameter is applied to the results of the operation, and the results of the application are output to the first activation function layer (ReLU1).

As indicated by a number “2”, the in-place process is executed by the first activation function layer (ReLU1). Specifically, the input neuron data items are stored in a memory region secured for the first activation function layer (ReLU1), and the activation function is applied to the input neuron data items to calculate output neuron data items. The output neuron data items are written over the input neuron data items stored in the memory region and are output to the second convolutional layer (Conv2).

As indicated by a number “3”, when the neuron data items output from the first activation function layer (ReLU1) are input to the second convolutional layer (Conv2), the convolution operation is executed on the neuron data items by the second convolutional layer (Conv2), a parameter is applied to the results of the operation, and the results of the application are input to the second activation function layer (ReLU2).

As indicated by a number “4”, the in-place process is executed by the second activation function layer (ReLU2). Specifically, the input neuron data items are stored in a memory region secured for the second activation function layer (ReLU2), the activation function is applied to the input neuron data items to calculate output neuron data items. The output neuron data items are written over the input neuron data item stored in the memory region and are output to the first pooling layer (Pool1).

As indicated by a number “5”, when the neuron data items output from the second activation function layer (ReLU2) are input to the first pooling layer (Pool1), the input neuron data items are decimated by the first pooling layer (Pool1) and the results of the decimation are input to the first fully-connected layer (Fully-conn1).

As indicated by a number “6”, when the neuron data items output from the first pooling layer (Pool1) are input to the first fully-connected layer (Fully-conn1), the first fully-connected layer (Fully-conn1) executes the full-connection operation on the neuron data items while applying a parameter to the neuron data items, and the results of the operation are input to the third activation function layer (ReLU3).

As indicated by a number “7”, the in-place process is executed by the third activation function layer (ReLU3). Specifically, the input neuron data items are stored in a memory region secured for the third activation function layer (ReLU3), and the activation function is applied to the input neuron data items to calculate output neuron data items. The output neuron data items are written over the input neuron data items stored in the memory region and are output to the second fully-connected layer (Fully-conn2).

As indicated by a number “8”, when the neuron data items output from the third activation function layer (ReLU3) are input to the second fully-connected layer (Fully-conn2), the second fully-connected layer (Fully-conn2) executes the full-connection operation on the neuron data items while applying a parameter to the neuron data items, and the results of the operation are input to the softmax layer (Softmax).

As indicated by the number “9”, the softmax layer (Softmax) executes the operation on the neuron data items using the activation function such as the softmax function, and the results of the operation are input to the output layer (Output).

Next, the learning process of updating the parameters based on the results of the recognition process is executed. For example, as indicated by a number “10”, in the learning process, errors between the results of the recognition process and correct data are calculated. Label indicates the correct data of the image of the target to be learned. Then, in the learning process, a process of calculating gradients of the errors of the layers between the recognition results and the correct data is executed in order from “11” to “21”. Then, in the learning process, as indicated by a number “22”, a process of changing the parameters of the layers is executed. The parameters may be changed when an error gradient is calculated for each of the layers.

A gradient (gdata) of an error with respect to a neuron data item of each of the intermediate layers that do not execute the in-place process may be calculated from an error gradient (gdata) of a preceding layer and a parameter (param) upon the recognition. For example, as indicated by “11”, in the second fully-connected layer (Fully-conn2), a gradient (gdata) of an error with respect to a neuron data item is calculated form an error gradient (gdata) of the softmax layer and the parameter (param) of the second fully-connected layer. A gradient (gparam) of an error with respect to a parameter of each of the intermediate layers that do not execute the in-place process may be calculated from an error gradient (gdata) of a preceding layer and a neuron data item (data) upon the recognition. For example, as indicated by “12”, in the second fully-connected layer, a gradient (gparam) of an error with respect to the parameter is calculated from an error gradient (gdata) of the softmax layer and a neuron data item (data) of the third activation function layer.

On the other hand, a gradient (gdata) of an error with respect to a neuron data item of each of the intermediate layers that execute the in-place process is calculated from an error gradient (gdata) of a preceding layer and a neuron data item (data) upon the recognition and stored in a memory region for the error gradient (gdata).

For example, as indicated by “13”, in the third activation function layer (ReLU3), a gradient (gdata) of an error with respect to a neuron data item is calculated from an error gradient (gdata), stored in a memory region indicated by “11”, of the second fully-connected layer (Fully-conn2) and a neuron data item (data) upon the recognition. Then, the gradient (gdata) of the error with respect to the neuron data item of the third activation function layer (ReLU3) is stored in a memory region for the error gradient (gdata).

For example, as indicated by “17”, in the second third activation function layer (ReLU2), a gradient (gdata) of an error with respect to a neuron data item is calculated from an error gradient (gdata), stored in a memory region indicated by “16”, of the first pooling layer (Pool1) and a neuron data item (data) upon the recognition. Then, the gradient (gdata) of the error with respect to the neuron data item of the second activation function layer (ReLU2) is stored in a memory region for the error gradient (gdata).

For example, as indicated by “20”, in the first activation function layer (ReLU1), a gradient (gdata) of an error with respect to a neuron data item is calculated from an error gradient (gdata), stored in a memory region indicated by “19”, of the second convolutional layer (Conv2) and a neuron data item (data) upon the recognition. Then, the gradient (gdata) of the error with respect to the neuron data item of the first activation function layer (ReLU1) is stored in a memory region for the error gradient (gdata).

In this manner, in the learning of the neural network, the parameters upon the recognition and neuron data items upon the recognition are used. Thus, in deep learning illustrated in FIG. 3, in the case where the learning is executed, neuron data items (data) and the parameters (param) upon the recognition of input neuron data items for learning are stored. In addition, in deep learning illustrated in FIG. 3, in the case where the learning is executed, gradients (gdata) of errors with respect to neuron data items and gradients (gparam) of errors with respect to the parameters are stored. In the learning, memory amounts to be used increase.

For example, a first method for reducing memory amounts to be used in the learning by analyzing a memory amount for each layer and contemplating the order of the operations is considered. In the first method, in the learning process, for each of layers in which neuron data items and parameters are held in memory regions, control is executed to calculate parameter errors and calculate neuron data item errors after the calculation of the parameter errors. If the first method is applied to the neural network, the process may be executed while executing overwriting on neuron data item storage regions upon the recognition, and memory amounts to be used may be reduced.

In the neural network illustrated in FIG. 3, however, it is difficult to treat, as neuron data items targeted for reductions in memory regions by the first method, neuron data items of the intermediate layers that execute the in-place process. For example, in the memory regions secured for the activation function layers (ReLU1, ReLU2, and ReLU3), output neuron data items are written over input neuron data items. Thus, if memory regions are additionally provided to save the input neuron data items in order to apply the first method, memory amounts to be used increase. Specifically, if memory regions whose sizes are equal to those of the input neuron data items are additionally provided, the effect, obtained by the in-place process, of the reductions in the memory amounts to be used may be lost.

Alternatively, for example, a second method for sharing inter-layer data of the multi-layered neural network and reducing memory amounts to be used is considered. In the second method, in each of the layers in which the neuron data items and the parameters are held in the memory regions, a gradient of an error with respect to either a neuron data item or parameter that causes a smaller memory amount to be used is calculated and held in a memory region. Then, a gradient of an error with respect to either the neuron data item or parameter that causes a larger memory amount to be used is calculated, and the calculated gradient is written over data obtained in the recognition process and held in a memory region. If the second method is applied to the neural network, memory amounts to be used upon the learning may be reduced.

In the neural network illustrated in FIG. 3, however, it is difficult to treat, as neuron data items targeted for reductions in memory regions by the second method, neuron data items of the intermediate layers that execute the in-place process. For example, in the memory regions secured for the activation function layers (ReLU1, ReLU2, and ReLU3), output neuron data items are written over input neuron data items. Thus, if memory regions are additionally provided to save the input neuron data items in order to apply the second method, memory amounts to be used increase. Specifically, if memory regions whose sizes are equal to those of the input neuron data items are additionally provided, the effect, obtained by the in-place process, of the reductions in the memory amounts to be used may be lost.

Thus, in the first embodiment, characteristic data that indicates signs of input neuron data items to the intermediate layers that execute the in-place process is stored in buffer regions upon the recognition process, and errors related to preceding intermediate layers are calculated using the characteristic data upon the learning process. Specifically, in the recognition process, in the intermediate layers that execute the in-place process, output neuron data items are not written over input neuron data items stored in the memory regions, and the input neuron data items remain. Then, added buffer regions with capacities corresponding to sign bits of the input neuron data items are secured and the sign bits are stored as the characteristic data in the added buffer regions. In the learning process, the intermediate layers that execute the in-place process multiply the characteristic data (sign bits) by the input neuron data items to generate output neuron data items and execute calculation on errors. It is, therefore, possible to suppress additional memory amounts to be used and improve the efficiency of using the memory. For example, an information processing apparatus 10 is configured as follows.

[Configuration of Information Processing Apparatus]

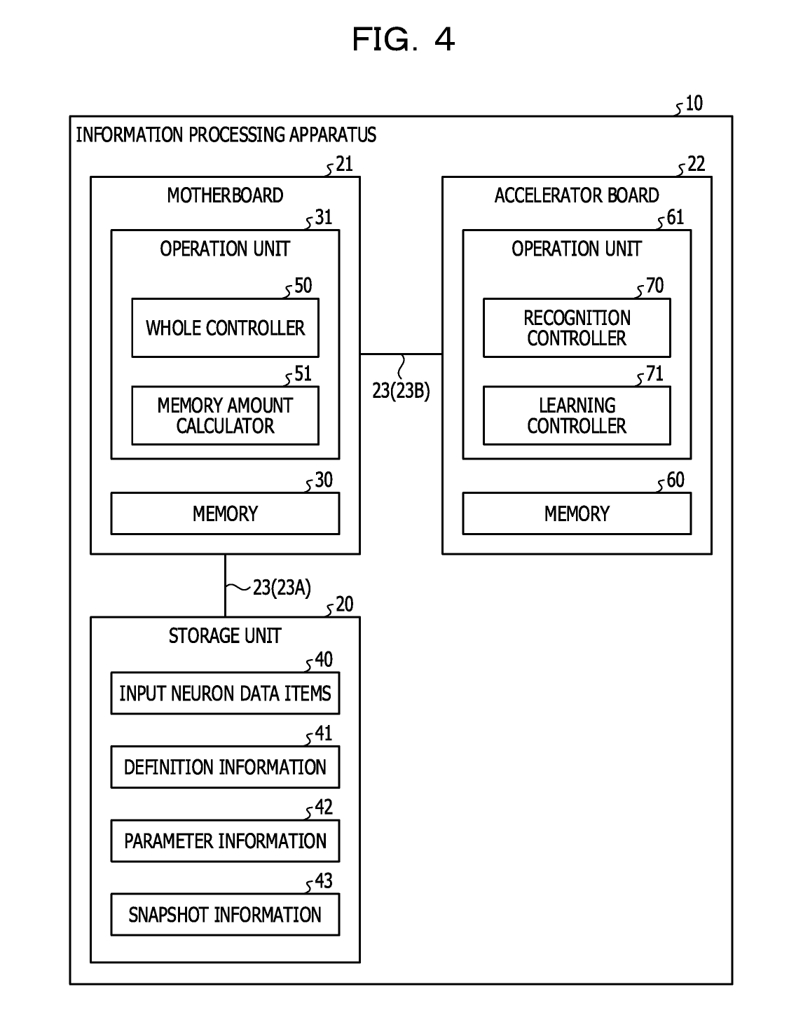

A configuration of the information processing apparatus 10 according to the first embodiment is described. FIG. 4 is a diagram schematically illustrating a functional configuration of the information processing apparatus. The information processing apparatus 10 is a recognition device that recognizes various targets using deep learning. For example, the information processing apparatus 10 is a computer such as a server computer. The information processing apparatus 10 may be implemented as a single computer or may be implemented as a computer system including multiple computers. Specifically, deep learning described below may be executed by an information processing system composed of multiple computers, while processes to be executed by the information processing system may be distributed. The present embodiment describes, as an example, the case where the information processing apparatus 10 is a single computer. The present embodiment describes an example in which the information processing apparatus 10 recognizes images.

As illustrated in FIG. 4, the information processing apparatus 10 includes a storage unit 20, a motherboard 21, and an accelerator board 22. The information processing apparatus 10 may include another unit other than the aforementioned units. For example, the information processing apparatus 10 may include an input unit for receiving various operations, a display unit for displaying various types of information, and the like.

The storage unit 20 is a storage device such as a hard disk or a solid state drive (SSD). The motherboard 21 is a board to which components serving as main functions of the information processing apparatus 10 are attached. The accelerator board 22 is a board on which hardware added and to be used to improve processing power of the information processing apparatus 10 is installed. Multiple accelerator boards 22 may be installed. The present embodiment describes, as an example, the case there the single accelerator board 22 is installed.

The storage unit 20, the motherboard 21, and the accelerator board 22 are connected to each other by a bus 23 through which data is transferred. For example, the storage unit 20 and the motherboard 21 are connected to each other by a bus 23A such as a Serial ATA (SATA) bus or a Serial Attached SCSI (SAS) bus. In addition, the motherboard 21 and the accelerator board 22 are connected to each other by a bus 23B such as a Peripheral Component Interconnect (PCI) Express bus.

In deep learning, operations are executed a large number of times. Thus, in the information processing apparatus 10, the processing speed is improved by executing the operations using the accelerator board 22 including an accelerator such as a graphics processing unit (GPU) or a dedicated chip.

The storage unit 20 stores an operating system (OS) and various programs for executing various processes described later. In addition, the storage unit 20 stores various types of information. For example, the storage unit 20 stores input neuron data items 40, definition information 41, parameter information 42, and snapshot information 43. The storage unit 20 may other types of information.

The input neuron data items 40 are data to be input to the neural network. For example, in the case where supervised learning is executed, the input neuron data items 40 are data for learning. For example, in the case where characteristics of a target included in an image and to be identified are learned by the neural network, the input neuron data items 40 are data in which a large number of images including various targets to be identified are associated with labels indicating correct data that indicates what the targets to be identified are. In addition, if the identification is executed by the neural network, the input neuron data items 40 are data treated as a target to be identified. For example, in the case where a target included in an image and to be identified is identified, the input neuron data items 40 are data of the image to be identified.

The definition information 41 is data storing information on the neural network. For example, in the definition information 41, information that indicates the configuration of the neural network and indicates the layered structure of the neural network, the configurations of units of the layers, connection relationships between the units, and the like is stored. In the case where the image recognition is executed, information that indicates the configuration of the convolutional neural network defined by a designer or the like is stored in the definition information 41, for example.

The parameter information 42 is data storing values of the parameters such as weight values to be used for the operations of the layers of the neural network. The values of the parameters stored in the parameter information 42 are predetermined initial values in an initial state and are updated based on the learning.

In the case where input neuron data items are divided into predetermined numbers of input neuron data items, and a batch process of the learning is repeated, the snapshot information 43 is data storing information in the middle of the process.

The motherboard 21 includes a memory 30 and an operation unit 31.

The memory 30 is, for example, a semiconductor memory such as a random access memory (RAM). The memory 30 stores information of processes to be executed by the operation unit 31 and various types of information to be used for the processes.

The operation unit 31 is a device that controls the entire information processing apparatus 10. As the operation unit 31, an electronic circuit such as a central processing unit (CPU) or a micro processing unit (MPU) may be used. The operation unit 31 functions as various processing units by executing various programs. For example, the operation unit 31 includes a whole controller 50 and a memory amount calculator 51.

The whole controller 50 controls an entire process related to deep learning. Upon receiving an instruction to start the deep learning process, the whole controller 50 reads, from the storage unit 20, various programs related to deep learning and various types of information on deep learning. For example, the whole controller 50 reads various programs for controlling the deep learning process. In addition, the whole controller 50 reads the definition information 41 and the parameter information 42. The whole controller 50 identifies the configuration of the neural network based on the definition information 41 and the parameter information 42 and determines the order of processes of the recognition process of the neural network and the order of processes of the learning process of the neural network. The whole controller 50 may determine the order of the processes of the learning process when the learning process is started.

The whole controller 50 divides the input neuron data items 40 into predetermined numbers of input neuron data items and reads the input neuron data items 40 from the storage unit 20. Then, the whole controller 50 offloads the read input neuron data items 40 and information on the recognition process and the learning process into the accelerator board 22. Then, the whole controller 50 controls the accelerator board 22 and causes the accelerator board 22 to execute the recognition process and learning process of the neural network.

The memory amount calculator 51 calculates memory amounts to be used to store data in deep learning. For example, the memory amount calculator 51 calculates, based on the definition information 41, memory amounts to be used to store neuron data items, the parameters, neuron data item errors, and parameter errors in the layers of the neural network.

The accelerator board 22 includes a memory 60 and an operation unit 61.

The memory 60 is, for example, a semiconductor memory such as a RAM. The memory 60 stores information of processes to be executed by the operation unit 61 and various types of information to be used for the processes.

The operation unit 61 is a device that controls the accelerator board 22. As the operation unit 61, an electronic circuit such as a graphics processing unit (GPU), an application specific integrated circuit (ASIC), or a field-programmable gate array (FPGA) may be used. The operation unit 61 functions as various processing units by executing various programs based on control by the whole controller 50. For example, the operation unit 61 includes a recognition controller 70 and a learning controller 71.

The recognition controller 70 controls the recognition process of the neural network. For example, the recognition controller 70 treats, as neuron data items, the input neuron data items offloaded from the motherboard 21 and executes the recognition process in accordance with the order of the processes. The recognition controller 70 executes the operations of the layers of the neural network on the neuron data items and causes the neuron data items and the parameters of the layers of the neural network to be held in the memory 60.

In this case, the recognition controller 70 secures additional memory regions in the memory 60 as memory regions for the intermediate layers that execute the in-place process and causes characteristic data corresponding to characteristics of input neuron data items to the intermediate layers to be stored in the additional memory regions. For example, if the input neuron data items are float-type data, the characteristic data may be sign bits of the input neuron data items. The recognition controller 70 leaves the input neuron data items stored in the memory regions for neuron data items.

The learning controller 71 controls the learning process of the neural network. For example, the learning controller 71 calculates errors between results of the identification by the recognition process and correct data and executes the learning process to cause the neural network to propagate the errors in accordance with the order of the processes. The learning controller 71 calculates error gradients of the layers of the neural network from the errors and learns the parameters.

In this case, the learning controller 71 uses the characteristic data stored in the buffer regions (additional memory regions) for the intermediate layers that execute the in-place process and calculates the errors related to the intermediate layers. Specifically, the learning controller 71 reads the input neuron data items from the memory regions for neuron data items of the intermediate layers that execute the in-place process and reads the characteristic data (sign bits) from the buffer regions. The learning controller 71 multiplies the input neuron data items by the characteristic data (sign bits) to generate output neuron data items and uses the generated output neuron data items to calculate errors (gdata, gparam) related to input neuron data items from the layers preceding the intermediate layers.

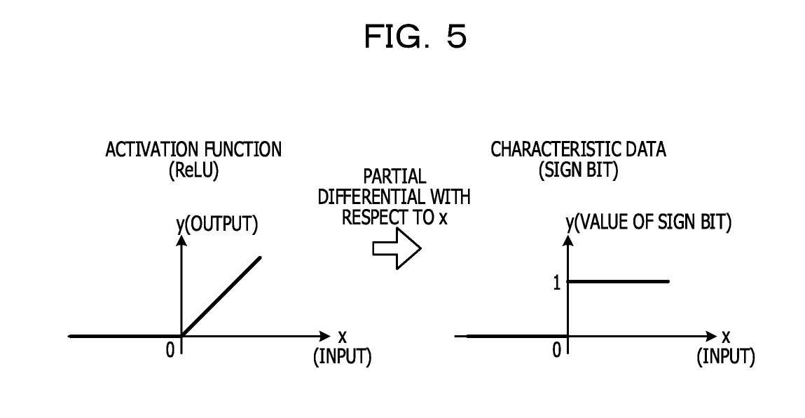

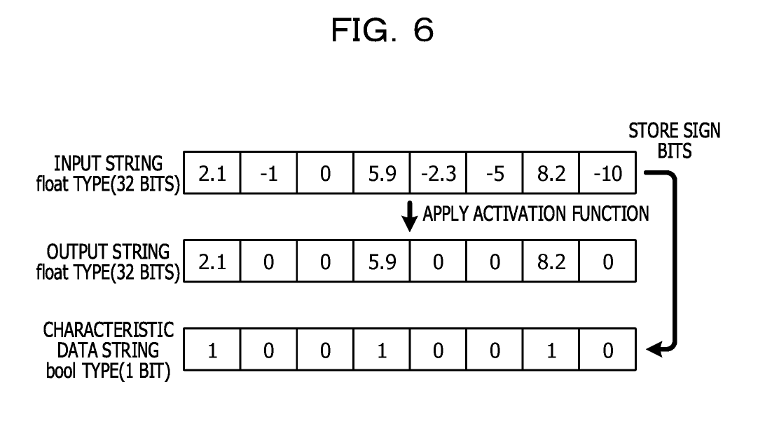

For example, in the calculation of error gradients, σ′(x) obtained by differentiating the activation function σ(x) with respect to x is used, as expressed by the aforementioned Equations (9) and (10-1). The value of σ′(x) may match the value of a sign bit indicating the sign of the input x, as illustrated in FIG. 5. FIG. 5 is a diagram illustrating relationships between the activation function and the characteristic data according to the first embodiment. Output y obtained by applying the activation function σ to the input x is also obtained by multiplying the value of the sign bit by the input x, as illustrated in FIG. 6. FIG. 6 is a diagram illustrating relationships between an input string, an output string, and a characteristic data string according to the first embodiment. Thus, if input neuron data items and the sign bits are saved upon the recognition process, output neuron data items upon the recognition process are reproduced by multiplying the input neuron data items by the sign bits upon the learning process.

In addition, for example, as illustrated in FIG. 6, the input neuron data items and the output neuron data items may be float-type 32-bit data items, the characteristic data (sign bits) may be bool-type 1-bit data items, and the number of bits may be suppressed. Thus, a memory region for storing a fail bitmap may be used as a memory region for storing the characteristic data (sign bits), and the efficiency at which the memory is used by the information processing apparatus 10 may be improved. For example, the amount of a memory for storing the characteristic data string (bitmap string) may be 1/32 of the amount of a memory for storing the input string and the amount of a memory for storing the output string. In addition, since the characteristic data may be stored in the memory region for storing the fail bitmap, the characteristic data may be referred to as bitmap data.

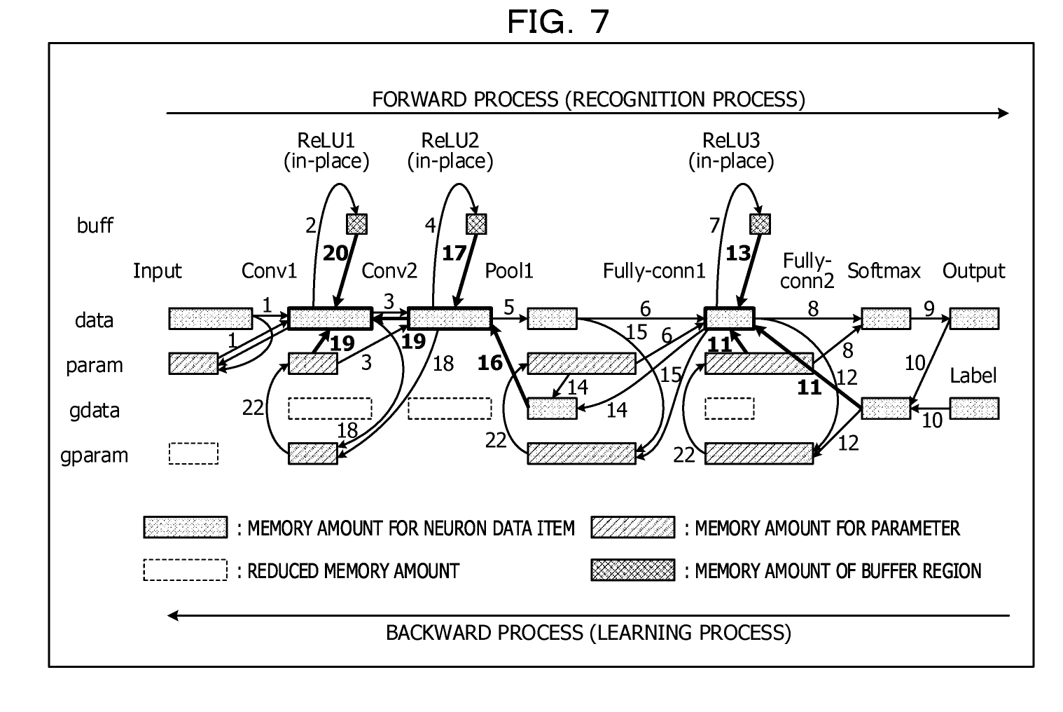

For example, the information processing apparatus 10 executes calculation different from the calculation of the neural network illustrated in FIG. 3 as follows, as illustrated in FIG. 7. FIG. 7 is a diagram illustrating an example of the flow of the calculation of the neural network according to the first embodiment. FIG. 7 exemplifies the case where the intermediate layers that execute the in-place process are the activation function layers (ReLU1, ReLU2, and ReLU3).

In FIG. 7, “buff” indicates data sizes of characteristic data (sign bits) stored in additional memory regions secured as buffer regions for the intermediate layers that execute the in-place process.

In the case where the learning of the neural network is executed, the recognition controller 70 executes the recognition process of identifying an image of a target to be learned. As illustrated in FIG. 7, the recognition controller 70 executes the processes of the layers in order from the number “1” to the number “10” and outputs the results of the processes. In this case, the recognition controller 70 secures the additional memory regions in the memory 60 as the buffer regions for the intermediate layers that execute the in-place process and causes the characteristic data corresponding to the characteristics of the input neuron data items to the intermediate layers to be stored in the additional memory regions.

For example, as indicated by the number “2”, input neuron data items (data) are stored in a memory region secured for data of the first activation function layer (ReLU1), and characteristic data (buff) indicating the signs of the input neuron data items is stored in a memory region for buffering. Each data size of the characteristic data may be suppressed to 1 bit. In the first activation function layer (ReLU1), the activation function is applied to the input neuron data items to calculate output neuron data items, and the output neuron data items are output to the second convolutional layer (Conv2).

For example, as indicated by the number “4”, the input neuron data items (data) are stored in a memory region secured for data of the second activation function layer (ReLU2), and characteristic data (buff) indicating the signs of the input neuron data items is stored in a memory region for buffering. Each data size of the characteristic data may be suppressed to 1 bit. In the second activation function layer (ReLU2), the activation function is applied to the neuron data items to calculate output neuron data items, and the output neuron data items are output to the first pooling layer (Pool1).

For example, as indicated by the number “7”, the neuron data items (data) are stored in a memory region secured for data of the third activation function layer (ReLU3), and characteristic data (buff) indicating the signs of the input neuron data items are stored in a memory region for buffering. Each data size of the characteristic data may be suppressed to 1 bit. In the third activation function layer (ReLU3), the activation function is applied to the input neuron data items to calculate output neuron data items, and the output neuron data items are output to the second fully-connected layer (Fully-conn2).

Next, the learning controller 71 executes the learning process of updating the parameters based on errors of identification results of the recognition process.

Gradients (gdata) of errors with respect to neuron data items of the intermediate layers that do not execute the in-place process are calculated from error gradients (gdata) of the preceding layers and the parameters (param) upon the recognition. For example, as indicated by “11”, in the second fully-connected layer (Fully-conn2), a gradient (gdata) of an error with respect to a neuron data item is calculated from an error gradient (gdata) of the softmax layer and the parameter (param) of the second fully-connected layer. Gradients (gparam) of errors with respect to the parameters of the intermediate layers that do not execute the in-place process may be calculated from error gradients (gdata) of the preceding layers and neuron data items (data) upon the recognition. For example, as indicated by “12”, in the second fully-connected layer, a gradient (gparam) of an error with respect to the parameter is calculated from an error gradient (gdata) of the softmax layer and a neuron data item (data) of the third activation function layer.

On the other hand, gradients (gdata) of errors with respect to neuron data items of the intermediate layers that execute the in-place process are calculated from error gradients (gdata) of the preceding layers and neuron data items (data) upon the recognition and written over the neuron data items (data), stored in memory regions, of the intermediate layers and stored in the memory regions.

For example, as indicated by “13”, in the third activation function layer (ReLU3), a gradient (gdata) of an error with respect to a neuron data item is calculated from the error gradient (gdata) of the second fully-connected layer (Fully-conn2) and a neuron data item (data) upon the recognition. The error gradient (gdata) of the second fully-connected layer (Fully-conn2) is calculated as indicated by “11”. The neuron data item (data) upon the recognition is an output neuron data item reproduced from the input neuron data item stored in a memory region for the neuron data item (data) and characteristic data (buff) stored in a buffer region. Then, the gradient (gdata) of the error with respect to the neuron data item of the third activation function layer (ReLU3) is written over the neuron data item (data), stored in the memory region, of the third activation function layer (ReLU3) and stored in the memory region.

For example, as indicated by “17”, in the second activation function layer (ReLU2), a gradient (gdata) of an error with respect to a neuron data item is calculated from an error gradient (gdata) of the first pooling layer (Pool1) and a neuron data item (data) upon the recognition. The error gradient (gdata) of the first pooling layer (Pool1) is calculated as indicated by “16”. The neuron data item (data) upon the recognition is an output neuron data item reproduced from the input neuron data item stored in a memory region for the neuron data item (data) and characteristic data (buff) stored in a buffer region. Then, the gradient (gdata) of the error with respect to the neuron data item of the second activation function layer (ReLU2) is written over the neuron data item (data), stored in the memory region, of the second activation function layer (ReLU2) and stored in the memory region.

For example, as indicated by “20”, in the first activation function layer (ReLU1), a gradient (gdata) of an error with respect to a neuron data item is calculated from an error gradient (gdata) of the second convolutional layer (Conv2) and a neuron data item (data) upon the recognition. The error gradient (gdata) of the second convolutional layer (Conv2) is calculated as indicated by “19”. The neuron data item (data) upon the recognition is an output neuron data item reproduced from the input neuron data item stored in a memory region for the neuron data item (data) and characteristic data (buff) stored in a buffer region. Then, the gradient (gdata) of the error with respect to the neuron data item of the first activation function layer (ReLU1) is written over the neuron data item (data), stored in the memory region, of the first activation function layer (ReLU1) and stored in the memory region.

In the learning process according to the present embodiment, memory regions indicated by broken lines in FIG. 7 may be reduced and the efficiency of using the memory upon the learning may be improved. Thus, for example, a batch size executable by the accelerator board 22 once is increased. Thus, if the reductions in the memory amounts to be used upon the learning described in the present embodiment are applied, it is possible to reduce a time period for the learning of input neuron data items.

[Flow of Process]

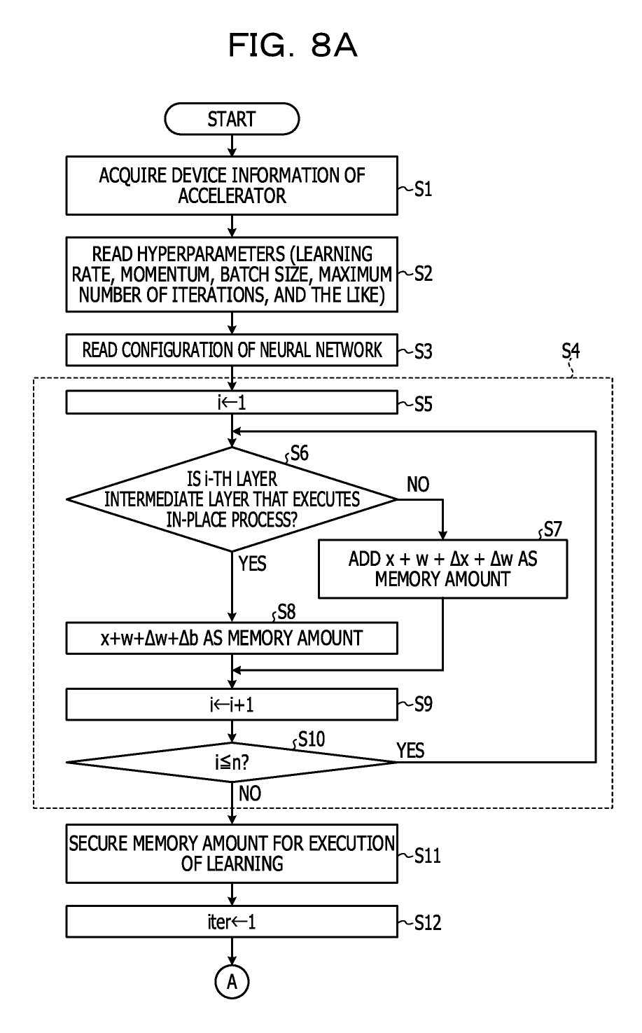

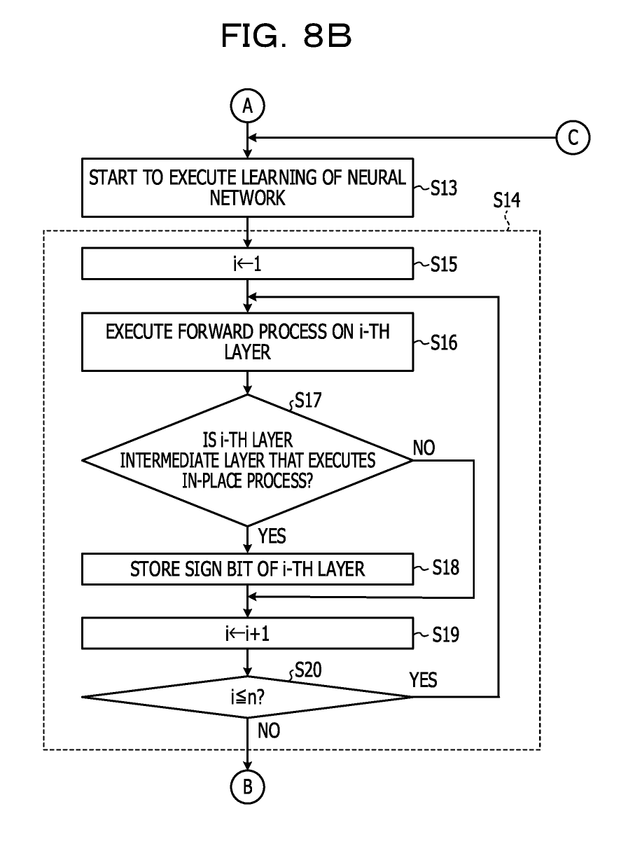

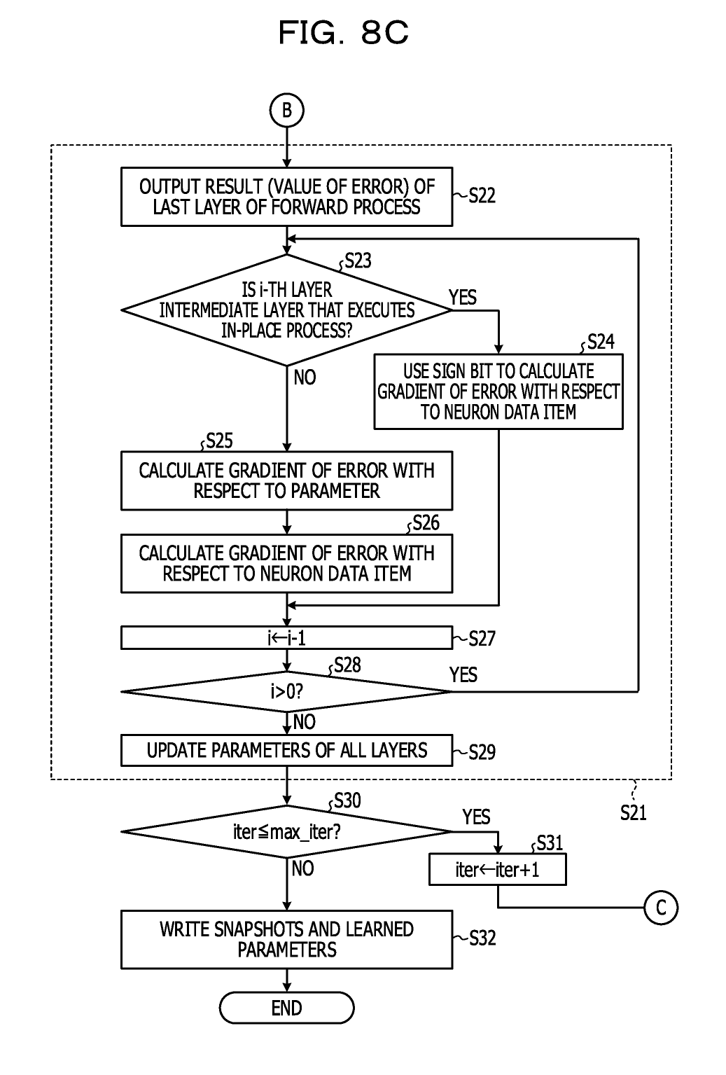

Next, the flow of a process in an information processing method to be executed by the information processing apparatus 10 is described. FIGS. 8A, 8B and 8C are flowcharts of an example of the information processing method according to the first embodiment. The information processing method is executed at predetermined time, for example, when the start of the process is instructed by an administrator.

For example, the case where all the activation function layers (ReLU1, ReLU2, and ReLU3) do not use any parameter is exemplarily described.

As illustrated in FIGS. 8A, 8B and 8C, the whole controller 50 reads the definition information 41 and the parameter information 42 (in S1). The whole controller 50 identifies hyperparameters (learning rate, momentum, batch size, maximum number of iterations, and the like) based on the definition information 41 and the parameter information 42 (in S2) and acquires the number max_iter of repeated executions of the learning. Then, the whole controller 50 identifies the configuration of the neural network based on the definition information 41 and the parameter information 42 (in S3) and acquires the number n of the layers.

The memory amount calculator 51 calculates, based on the definition information 41, data sizes corresponding to memory amounts to be used to store neuron data item errors and parameter errors for the layers of the neural network upon the recognition and the learning (in S4). Specifically, the memory amount calculator 51 initializes a parameter i for counting the number of layers to 1 (in S5) and determines whether or not an i-th layer is an intermediate layer that executes the in-place process (in S6).

If the i-th layer is not the intermediate layer that executes the in-place process (No in S6), the memory amount calculator 51 secures “x+w+Δx+Δw” as a memory amount for the i-th layer (in S7). “x” indicates the data size of input x, w″ indicates the data size of a parameter w″, “Δx” indicates the data size of an input error Δx, “Δw” indicates the data size of a parameter error Δw. If the i-th layer is the intermediate layer that executes the in-place process (Yes in S6), The memory amount calculator 51 secures “x+w+Δw+Δb” as the memory amount for the i-th layer (in S8). “x” indicates the data size of the input x, “w” indicates the data size of the parameter w, “Δw” indicates the size of the parameter error Δw, and “Δb” indicates the data size of a sign bit of the input x. In this case, the data size of the sign bit of the input x is smaller than the data size of the input error Δx (Δb<Δx is established). If the i-th layer does not use a parameter, the memory amount calculator 51 may omit the calculation of the data size of the parameter w and the calculation of the data size of the parameter error Δw.

The memory amount calculator 51 adds 1 to the parameter i (in S9). The memory amount calculator 51 repeats the processes of S6 to S9 until the parameter i becomes equal to or larger than the number n of the layers of the neural network.

When the parameter i becomes equal to or larger than the number n of the layers of the neural network, the whole controller 50 controls the accelerator board 22 and secures memory regions for the calculated data sizes in the memory 60 (in S11). In addition, the whole controller 50 initializes a parameter iter for counting the number of executions of the learning to 1 (in S12).

The whole controller 50 divides the input neuron data items 40 into predetermined numbers of input neuron data items and reads the input neuron data items 40 from the storage unit 20. Then, the whole controller 50 offloads the read data and information on the recognition process and the learning process into the accelerator board 22, starts the learning of the neural network (in S13), executes the recognition process (in S14), and executes the learning process (in S21).

In the recognition process (of S14), the recognition controller 70 initializes the parameter i for counting the number of layers to 1 (in S15). The recognition controller 70 reads a single unprocessed data item from the data offloaded from the motherboard 21. Then, the recognition controller 70 treats the read data item as a neuron data item, executes an operation of the i-th layer on the neuron data item in the forward process of the neural network, and causes the result of the operation to be held in the memory 60 (in S16). The recognition controller 70 determines whether or not the i-th layer is an intermediate layer that executes the in-place process (in S17). If the i-th layer is not the intermediate layer that executes the in-place process (No in S17), the recognition controller 70 causes the operation result to be stored in a memory region for the neuron data item and causes the process to proceed to S19. If the i-th layer is the intermediate layer that executes the in-place process (Yes in S17), the recognition controller 70 causes the sign bit of the input neuron data item to be stored in a buffer region (in S18). The recognition controller 70 adds 1 to the value of the parameter i (in S19). The recognition controller 70 repeats the processes of S16 to S19 until the parameter i becomes equal to or larger than the number n of the layers of the neural network. When the parameter i becomes equal to or larger than the number n of the layers of the neural network, the process proceeds from the recognition process (in S14) to the learning process (in S21).

In the learning process (in S21), the learning controller 71 calculates an error between the result of the identification by the last layer of the neural network and correct data (in S22). The learning controller 71 determines whether or not the i-th layer is an intermediate layer that executes the in-place process (in S23). If the i-th layer is the intermediate layer that executes the in-place process (Yes in S23), the learning controller 71 uses the sign bit stored in the buffer region to calculate a gradient of an error with respect to the neuron data item and causes the calculated error gradient to be written over the neuron data item stored in the memory region for the neuron data item and to be stored in the memory region (in S24). If the i-th layer is not the intermediate layer that executes the in-place process (No in S23), the learning controller 71 calculates a gradient of an error with respect to a parameter and causes the error gradient to be held in the memory 60 (in S25). If the i-th layer does not use a parameter, the learning controller 71 may omit the process of S25. Then, the learning controller 71 calculates a gradient of an error with respect to the neuron data item and causes the error gradient to be held in the memory 60 (in S26). The learning controller 71 subtracts 1 from the parameter i (in S27). The learning controller 71 repeats the processes of S23 to S27 until the parameter i becomes equal to or lower than 0. When the parameter i becomes equal to or lower than 0, the learning controller 71 updates the parameters based on gradients of errors with respect to the parameters of all the layers of the neural network (in S29) and terminates the learning process (of S21).

The whole controller 50 repeats the processes of S13 to S29 and adds 1 to the parameter iter (in S31) until the parameter iter becomes equal to or larger than the number max_iter of repeated executions of the learning. When the parameter iter becomes equal to or larger than the number max_iter of repeated executions of the learning, the whole controller 50 causes the results of the processes to be stored in the snapshot information 43 and the parameter information 42 (in S32) and terminates the process.

[Effects]

As described above, the information processing apparatus 10 according to the present embodiment stores, upon the recognition process in a buffer region, characteristic data indicating the sign of an input neuron data item to an intermediate layer that executes the in-place process, and the information processing apparatus 10 according to the present embodiment uses the characteristic data to calculate an error related to the intermediate layer upon the learning process. Specifically, in the recognition process, in the intermediate layer that executes the in-place process, an output neuron data item is not written over the input neuron data item stored in a memory region, and the input neuron data item stored in the memory region remains. Then, an additional buffer region with a capacity corresponding to the sign bit of the neuron data item is secured, and the sign bit is stored as characteristic data in the additional buffer region. In the learning process, in the intermediate layer that executes the in-place process, the input neuron data item is multiplied by the characteristic data (sign bit) to generate an output neuron data item, and an error gradient (gdata) related to the neuron data item from a layer preceding the intermediate layer is calculated. Thus, additional memory amounts to be used may be suppressed and the efficiency of using the memory may be improved.

In addition, in the information processing apparatus 10 according to the present embodiment, the storage capacity of an additional buffer region is smaller than the storage capacity of a memory region sharable for input and output neuron data items. Thus, additional memory amounts to be used may be suppressed and the efficiency of using the memory may be improved.

In addition, in the information processing apparatus 10 according to the present embodiment, characteristic data stored in an additional buffer region includes a sign bit of an input neuron data item. Thus, the storage capacity of an additional buffer region may be smaller than the storage capacity of a memory region sharable for input and output neuron data items.

### Second Embodiment

Next, a second embodiment is described. Since the configuration of an information processing apparatus 10 according to the second embodiment is substantially the same as the configuration, illustrated in FIG. 4, of the information processing apparatus 10 according to the first embodiment, different features are mainly described.

For example, the case where the activation function layers (ReLU1 and ReLU2) among the activation function layers (ReLU1, ReLU2, and ReLU3) do not use any parameter and the activation function layer (ReLU3) uses the parameter is exemplarily described.

The memory amount calculator 51 determines whether or not the data size of an input neuron data item to an intermediate layer that executes the in-place process is larger than the data size of a parameter. If the data size of the input neuron data item to the intermediate layer that executes the in-place process is larger than the data size of the parameter, the memory amount calculator 51 calculates an additional memory amount as a buffer region for the intermediate layer.

If the data size of the input neuron data item to the intermediate layer that executes the in-place process is larger than the data size of the parameter, the recognition controller 70 secures an additional memory region in the memory as the buffer region for the intermediate layer. If data size of the input neuron data item to the intermediate layer that executes the in-place process is equal to or smaller than the data size of the parameter, the recognition controller 70 does not secure the additional memory region.

If the data size of the input neuron data item to the intermediate layer that executes the in-place process is larger than the data size of the parameter, the learning controller 71 uses characteristic data stored in the buffer region (additional memory region) to calculate an error related to the intermediate layer. If the data size of the input neuron data item to the intermediate layer that executes the in-place process is equal to or smaller than the data size of the parameter, the learning controller 71 uses a neuron data item stored in a memory region for the neuron data item to calculate the error related to the intermediate layer.

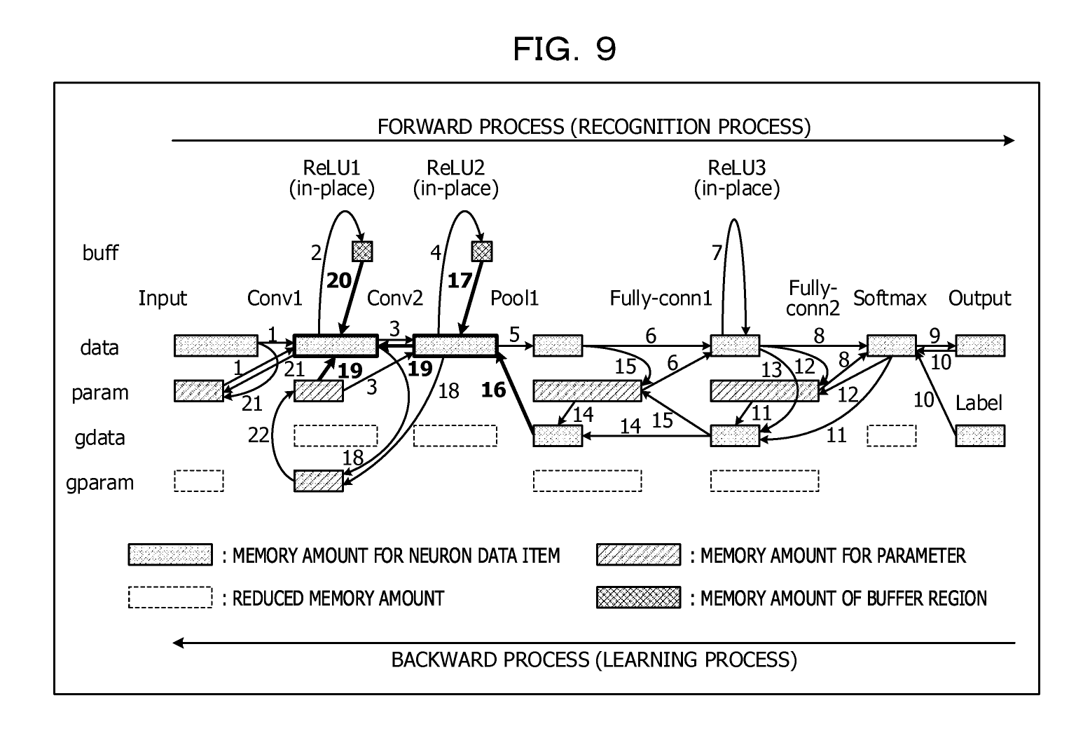

For example, as illustrated in FIG. 9, the information processing apparatus 10 treats the data size of an input neuron data item as a data size larger than the data size of a parameter and executes the same processes as described in the first embodiment for each of the activation function layers (ReLU1 and ReLU2). FIG. 9 is a diagram illustrating an example of the flow of calculation of a neural network according to the second embodiment. In the activation function layer (ReLU3) that is the intermediate layer that executes the in-place process, the data size of the input neuron data item is equal to or smaller than the data size of the parameter, and the following process is executed. That is, the learning controller 71 calculates a gradient of an error with respect to either the neuron data item or parameter that causes a smaller memory amount to be used, and the learning controller 71 causes the calculated gradient to be held in a memory region. Then, the learning controller 71 calculates a gradient of an error with respect to either the neuron data item or parameter that causes a larger memory amount to be used, and the learning controller 71 causes the calculated gradient to be written over data obtained in the recognition process and held in a memory region.

In the learning process according to the present embodiment, memory regions indicated by broken lines in FIG. 9 may be reduced and the efficiency of using the memory upon the learning may be improved. Thus, for example, a batch size executable by the accelerator board 22 once is increased. Thus, if the reductions in the memory amounts to be used upon the learning described in the present embodiment are applied, it is possible to reduce a time period for the learning of input neuron data items.

[Flow of Process]

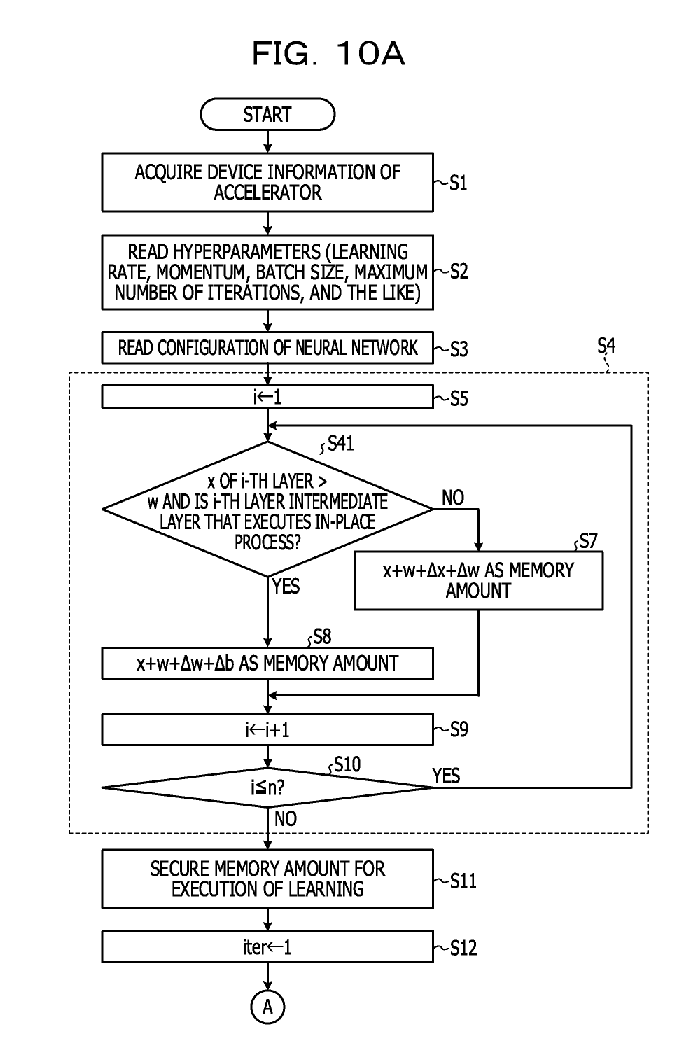

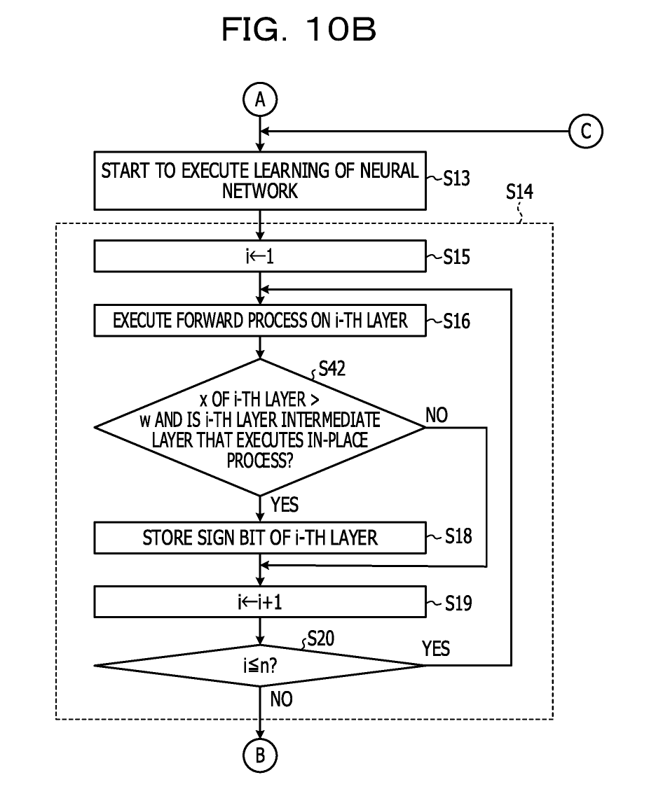

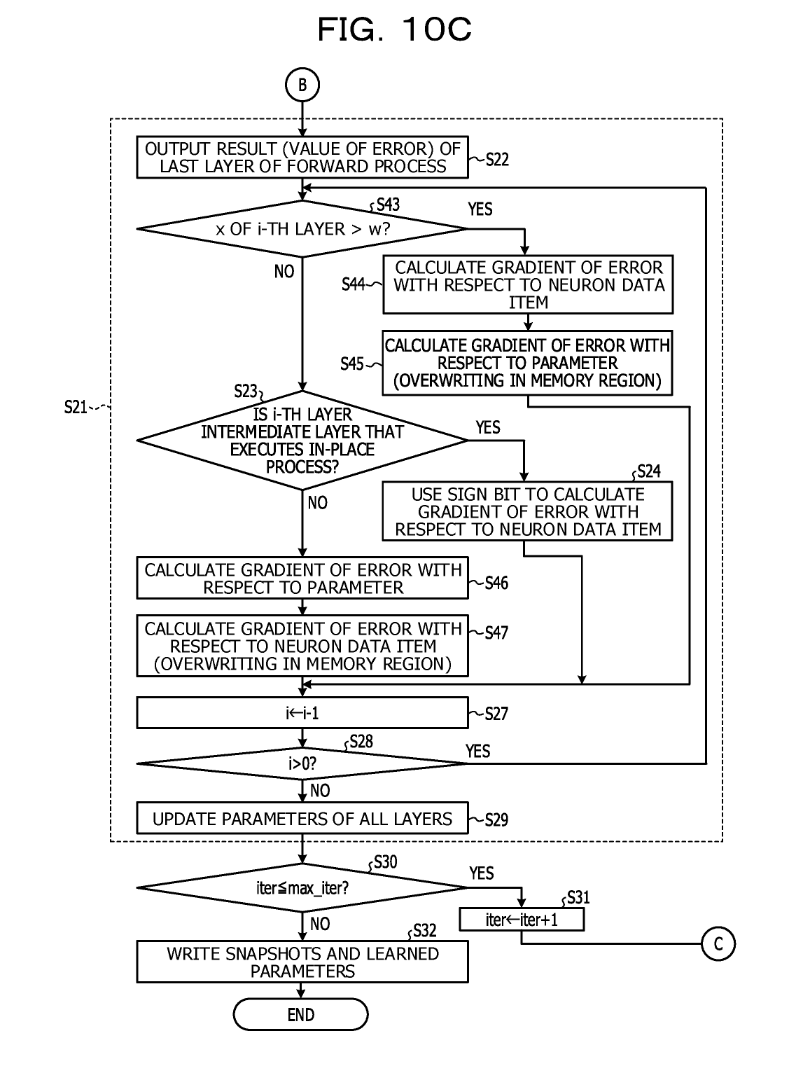

Next, the flow of a process in an information processing method to be executed by the information processing apparatus 10 is described. FIGS. 10A, 10B and 10C are flowcharts illustrating an example of the information processing method according to the second embodiment. The information processing method according to the second embodiment is basically the same as the information processing method according to the first embodiment, but different processes are executed in the following respects.

In the process (of S4) of calculating a data size corresponding to a memory amount to be used, after S5, the memory amount calculator 51 determines whether or not the data size of an input neuron data item x of an i-th layer is larger than the data size of a parameter w and whether or not the i-th layer is an intermediate layer that executes the in-place process (in S41). If the data size of the input neuron data item x of the i-th layer is equal to or smaller than the data size of the parameter w or if the i-th layer is not the intermediate layer that executes the in-place process (No in S41), the memory amount calculator 51 executes the process of S7. If the data size of the input neuron data item x of the i-th layer is larger than the data size of the parameter w and if the i-th layer is the intermediate layer that executes the in-place process (Yes in S41), the memory amount calculator 51 executes the process of S8.

In the recognition process (of S14), after S16, the recognition controller 70 determines whether or not the data size of the input neuron data item x of the i-th layer is larger than the data size of a parameter w and whether or not the i-th layer is an intermediate layer that executes the in-place process (in S42). If the data size of the input neuron data item x of the i-th layer is equal to or smaller than the data size of the parameter w or if the i-th layer is not the intermediate layer that executes the in-place process (No in S42), the recognition controller 70 causes an operation result to be stored in a memory region for the neuron data item and causes the process to proceed to S19. If the data size of the input neuron data item x of the i-th layer is larger than the data size of the parameter w and if the i-th layer is the intermediate layer that executes the in-place process (Yes in S42), the recognition controller 70 causes the sign bit of the input neuron data item to be stored in a buffer region (in S18).

In the learning process (of S21), after S22, the learning controller 71 determines whether or not the data size of the input neuron data item x of the i-th layer is larger than the data size of the parameter w (in S43). If the data size of the input neuron data item x of the i-th layer is equal to or smaller than the data size of the parameter w (No in S43), the learning controller 71 calculates a gradient of an error with respect to the neuron data item and causes the gradient to be held in the memory 60 (in S44). Then, the learning controller 71 calculates a gradient of an error with respect to the parameter and causes the calculated gradient to be written over data stored in a storage region included in the memory 60 and storing the parameter of the i-th layer of the neural network and to be stored in the storage region (in S45).

On the other hand, if the data size of the input neuron data item x of the i-th layer is larger than the data size of the parameter w (Yes in S43), the learning controller 71 determines whether or not the i-th layer is an intermediate layer that executes the in-place process (in S23). If the i-th layer is not the intermediate layer that executes the in-place process (No in S23), the learning controller 71 calculates a gradient of an error with respect to the parameter and causes the gradient to be held in the memory 60 (in S46). If the i-th layer does not use any parameter, the learning controller 71 may omit the process of S46. Then, the learning controller 71 calculates a gradient of an error with respect to the neuron data item and causes the calculated gradient to be written over the neuron data item, stored in a memory region of the memory 60, of the i-th layer of the neural network and to be stored in the memory region (in S47).

[Effects]

As described above, the information processing apparatus 10 according to the present embodiment switches details of the process based on whether or not the data size of an input neuron data item x of an intermediate layer that executes the in-place process is larger than the data size of a parameter w. Specifically, if the data size of the input neuron data item x of the intermediate layer that executes the in-place process is larger than the data size of the parameter w, the same processes as described in the first embodiment are executed. On the other hand, if the data size of the input neuron data item x of the intermediate layer that executes the in-place process is equal to or smaller than the data size of the parameter w, the following process is executed. In the learning process, the information processing apparatus 10 calculates a gradient of an error with respect to either the neuron data item or parameter that causes a smaller memory amount to be used, and the information processing apparatus 10 holds the gradient in a memory region. Then, the information processing device 10 calculates a gradient of an error with respect to either the neuron data item or parameter that causes a larger memory amount to be used, and the information processing apparatus 10 causes the calculated gradient to be written over data obtained in the recognition process and held in a memory region. Thus, the information processing apparatus 10 may further reduce memory amounts to be used upon the learning.

### Third Embodiment

Next, a third embodiment is described. Since the configuration of an information processing apparatus 10 according to the third embodiment is substantially the same as the configuration, illustrated in FIG. 4, of the information processing apparatus 10 according to the first embodiment, different features are mainly described.

The learning controller 71 identifies a memory amount to be used for a layer that uses the largest memory amount among memory amounts calculated by the memory amount calculator 51 and to be used for parameter errors of the layers. Then, upon the start of the learning process, the learning controller 71 secures, as a storage region for the parameter errors, a memory region corresponding to the identified memory amount to be used. In the learning process, the learning controller 71 executes the following process sequentially for each of layers for which neuron data items and parameters are held in memory regions. The learning controller 71 calculates a parameter error and causes the parameter error to be written over data stored in a storage region for the parameter error and to be stored in the storage region for the parameter error. Next, the learning controller 71 calculates a neuron data item error and causes the neuron data item error to be written over a neuron data item obtained in the recognition process and held in a memory region and to be held in the memory region. Next, the learning controller 71 uses the parameter error held in the storage region for the parameter error to update the parameter held by the recognition process.

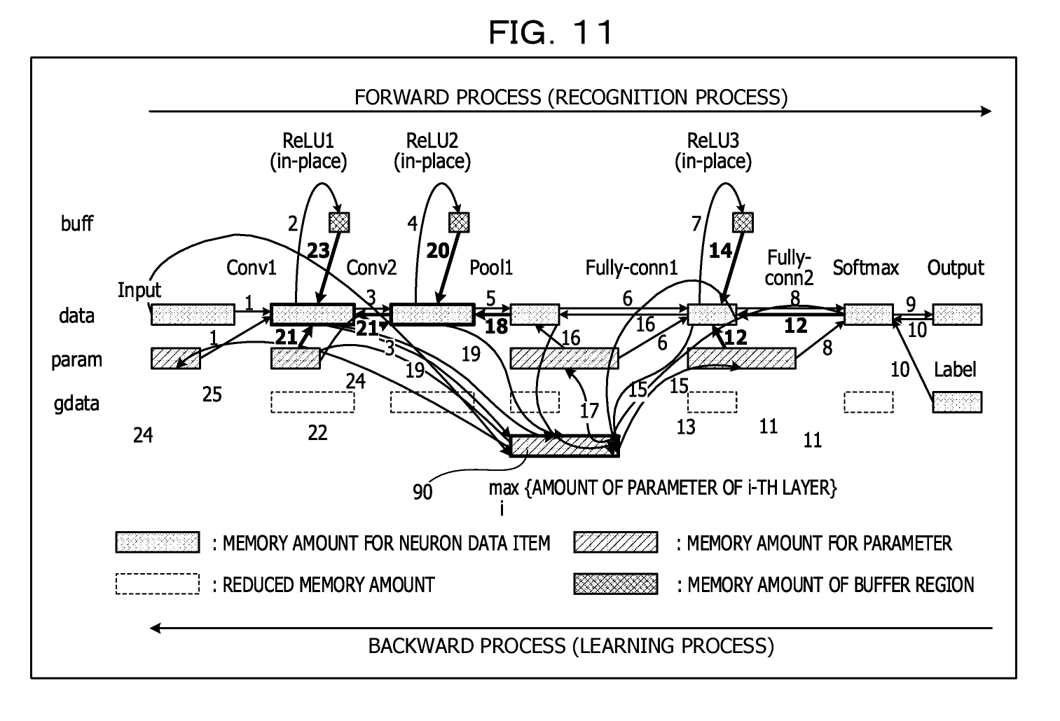

For example, as illustrated in FIG. 11, the information processing apparatus 10 executes the processes described in the first embodiment and additional control for each of the intermediate layers. The additional control includes control to be executed to calculate a parameter error for each of layers using parameters and cause the calculated parameter errors to be written data stored in the storage region 90 for parameter errors and to be held in the storage region 90. FIG. 11 is a diagram illustrating an example of the flow of calculation of a neural network according to the third embodiment.

For example, as indicated by a number “15”, for the activation function layer (ReLU3), the learning controller 71 calculates a parameter error and causes the calculated parameter error to be held in the storage region 90 for parameter errors that is included in the memory 60. Next, as indicated by the number “16”, the learning controller 71 calculates a neuron data item error and causes the neuron data item error to be written over a neuron data item obtained in the recognition process and held in a memory region of the memory 60 and to be held in the memory region. Next, as indicated by the number “17”, the learning controller 71 uses the parameter error held in the storage region 90 for parameter errors to update the parameter held by the recognition process. Thus, a memory region for storing a gradient of an error with respect to a neuron data item for each of the intermediate layers may be reduced, compared with the calculation of the neural network illustrated in FIG. 7.

In the learning process according to the present embodiment, memory regions indicated by broken lines in FIG. 11 may be reduced and the efficiency of using the memory upon the learning may be improved. Thus, for example, a batch size executable by the accelerator board 22 once is increased. Thus, if the reductions in the memory amounts to be used upon the learning described in the present embodiment are applied, it is possible to reduce a time period for the learning of input neuron data items.

[Flow of Process]

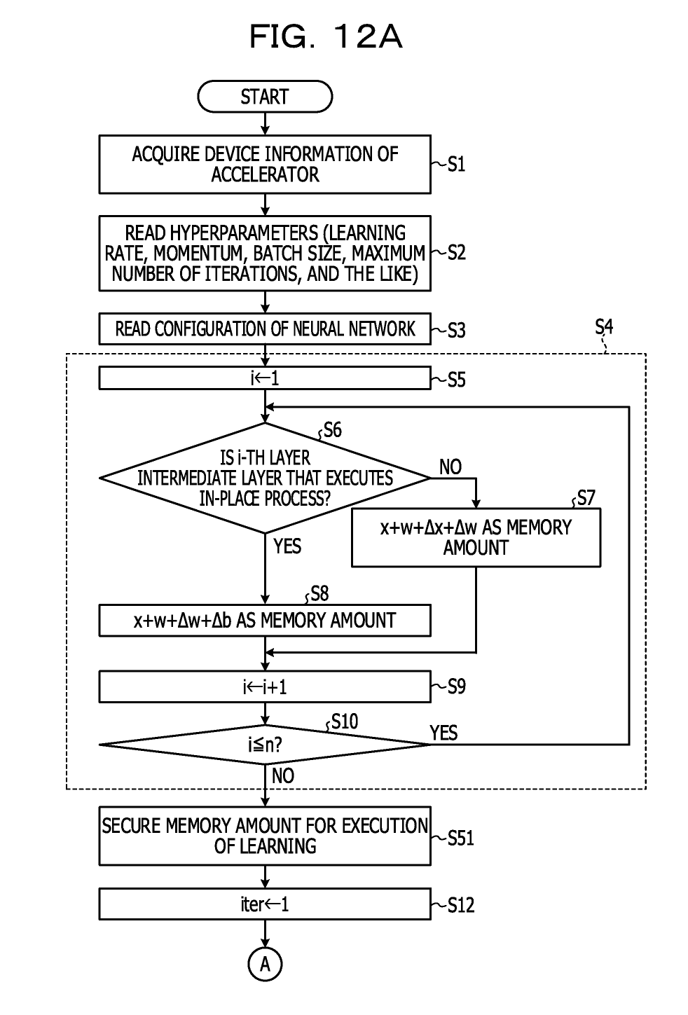

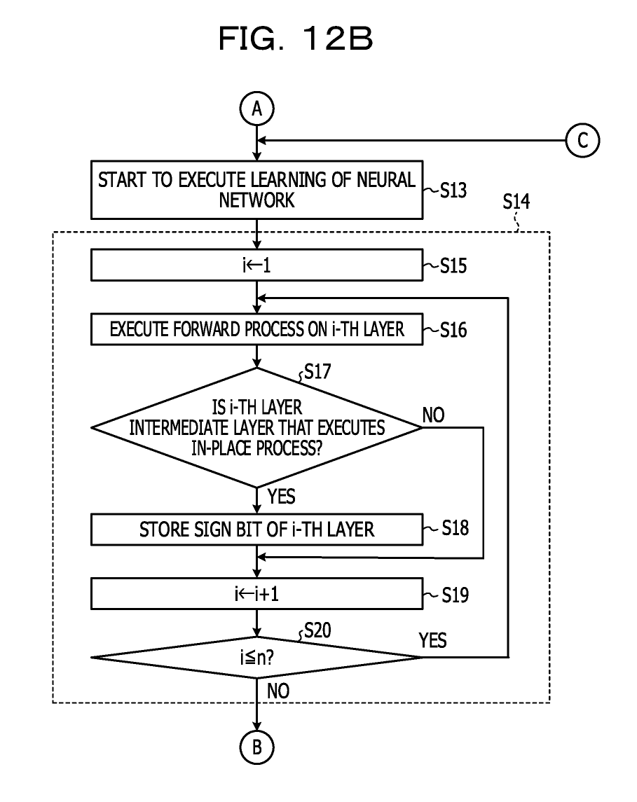

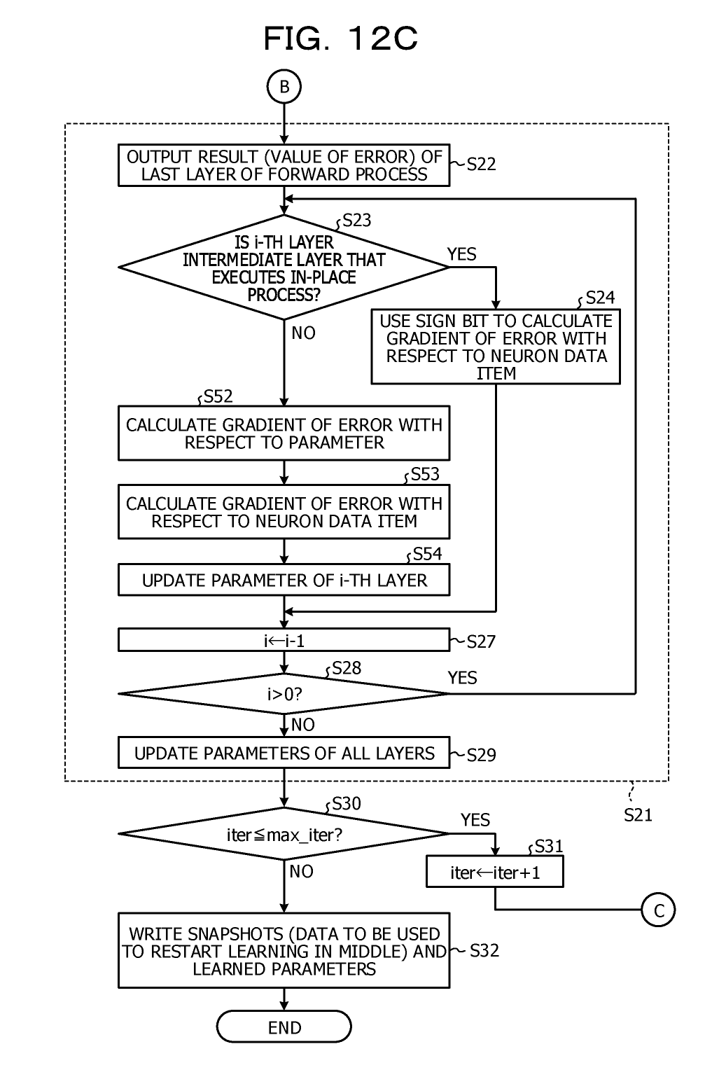

Next, the flow of a process in an information processing method to be executed by the information processing apparatus 10 is described. FIGS. 12A, 12B and 12C are flowcharts of an example of the information processing method according to the third embodiment. Since the information processing method according to the third embodiment is basically the same as the information processing method according to the first embodiment, different processes are executed in the following respects.

For example, the case where all the activation function layers (ReLU1, ReLU2, and ReLU3) do not use any parameter and the other intermediate layers use the parameters is exemplarily described.

The memory amount calculator 51 repeats the processes of S5 to S9 until the parameter i becomes equal to or larger than the number n of the layers of the neural network. When the parameter i becomes equal to or larger than the number n of the layers of the neural network, the whole controller 50 secures storage regions for the calculated data sizes in the memory 60 (in S51). In this case, the whole controller 50 identifies a memory amount to be used for a layer that uses the largest memory amount among the calculated memory amounts to be used for parameter errors of the layers. Then, the whole controller 50 secures, as the storage region 90 for parameter errors, a memory region corresponding to the identified memory amount to be used.

In the learning process (S21), if an i-th layer is not an intermediate layer that executes the in-place process (No in S23), the learning controller 71 calculates a gradient of an error with respect to a parameter and causes the gradient of the error with respect to the parameter to be held in the storage region 90 for parameter errors that is included in the memory 60 (in S52). If the i-th layer does not use a parameter, the learning controller 71 may omit the process of S52. Then, the learning controller 71 calculates a gradient of an error with respect to a neuron data item and causes the calculated gradient to be written over a neuron data item, stored in a memory region of the memory 60, of the i-th layer of the neural network and to be held in the memory region (in S53). Then, the learning controller 71 uses the parameter error held in the storage region 90 for parameter errors to update the parameter, held by the recognition process, of the i-th layer (in S54).

[Effects]

As described above, the information processing apparatus 10 according to the present embodiment calculates memory amounts to be used for parameter errors of the layers of the neural network. The information processing apparatus 10 secures a memory region corresponding to a memory amount to be used for a layer that uses the largest memory amount among memory amounts calculated for the layers. In the learning process, the information processing apparatus 10 executes control to sequentially execute the following processes for each of the layers for which neuron data items and parameters are held in memory regions. First, the information processing apparatus 10 calculates a parameter error and causes the parameter error to be written over data stored in a secured memory region and to be held in the secured memory region. Next, the information processing apparatus 10 calculates a neuron data item error and causes the neuron data item error to be written over a neuron data item obtained in the recognition process and stored in a memory region and to be held in the memory region. Next, the information processing apparatus 10 uses the parameter error held in the secured memory region to update the parameter held by the recognition process. Thus, the information processing apparatus 10 may reduce memory amounts to be used upon the learning.

The aforementioned embodiments exemplify the case where a target included in an image and to be identified is identified by the neural network. The embodiments, however, are not limited to this. For example, the target to be identified may be any target that is identified by the neural network and is, for example, a sound or the like.

In addition, the aforementioned embodiments exemplify the case where the convolutional neural network (CNN) is used as the neural network. The embodiments, however, are not limited to this. For example, the neural network may be a neural network that is able to learn and recognize time-series data and is a recurrent neural network (RNN) or the like. The RNN is an expansion of the CNN and executes backpropagation, like the CNN, and the same processes described in the aforementioned embodiments are applicable to the RNN.

In addition, each of the aforementioned embodiments exemplifies the case where a single information processing apparatus 10 executes the recognition process and the learning process. The embodiments, however, are not limited to this. For example, an information processing system in which the recognition process and the learning process are executed by multiple information processing apparatuses 10 may be configured. For example, if input neuron data items are processed by a minibatch method, the input neuron data items may be processed as follows. That is, an information processing apparatus 10 may divide the input neuron data items into numbers M of neuron data items, and another information processing apparatus 10 may execute the recognition process and the learning process, collect calculated parameter errors, and update the parameters.

In addition, the aforementioned embodiments exemplify the case where the memory amount calculator 51 is installed in the operation unit 31 of the motherboard 21. The embodiments, however, are not limited to this. For example, the memory amount calculator 51 may be installed in the operation unit 61 of the accelerator board 22. The memory amount calculator 51 installed in the operation unit 61 of the accelerator board 22 may calculate memory amounts to be used to store neuron data items and the parameters for the layers of the neural network.

The aforementioned embodiments exemplify the case where the memory amounts to be used for the recognition process and the learning process are calculated before the start of the recognition process. The embodiments, however, are not limited to this. For example, the memory amounts to be used for the recognition process may be calculated before the start of the recognition process, and the memory amounts to be used for the learning process may be calculated after the termination of the recognition process and before the start of the learning process.

In addition, the constituent elements of the devices illustrated in the drawings are functionally conceptual and may not be physically configured as illustrated in the drawings. Specifically, specific forms of the separation and integration of the devices are not limited to the illustrated forms, and all or a portion thereof may be separated and integrated in arbitrary units in either a functional or physical manner depending on various loads, usage states, and the like. For example, the processing units that are the whole controller 50, the memory amount calculator 51, the recognition controller 70, and the learning controller 71 may be integrated. In addition, each of the processes to be executed by the processing units may be separated into processes to be executed by multiple processing units. In addition, all or an arbitrary part of the processing functions to be executed by the processing units may be achieved by a CPU and a program analyzed and executed by the CPU or may be achieved as hardware by wired logic.

[Information Processing Program]

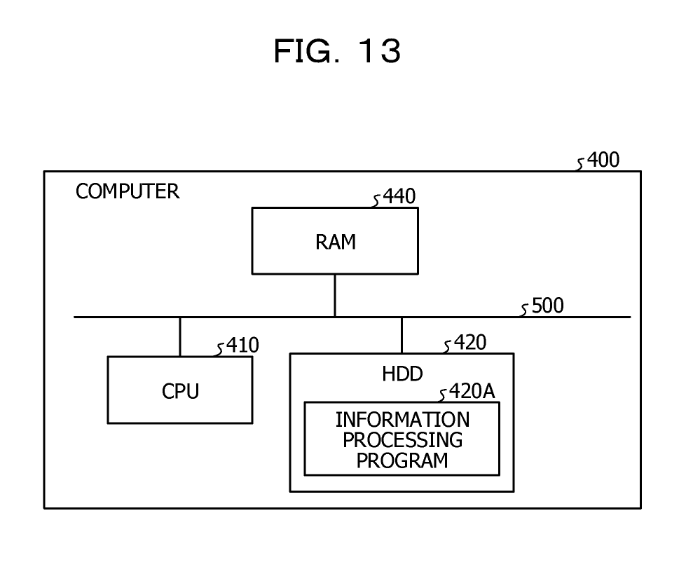

In addition, the various processes described in the embodiments may be achieved by causing a computer system such as a personal computer or a workstation to execute a program prepared in advance. An example of the computer system that achieves the information processing program is described below. FIG. 13 is a diagram illustrating an example of the configuration of a computer that executes the information processing program.

As illustrated in FIG. 13, a computer 400 includes a central processing unit (CPU) 410, a hard disk drive (HDD) 420, and a random access memory (RAM) 440. The units 410 to 440 are connected to each other via a bus 500.

In the HDD 420, an information processing program 420A that achieves the same functions as the aforementioned whole controller 50, the memory amount calculator 51, the recognition controller 70, and the learning controller 71 is stored in advance. The information processing program 420A may be divided.

In addition, the HDD 420 stores various types of information. For example, the HDD 420 stores the OS, the various programs, and the various types of information, like the storage unit 20.

The CPU 410 executes the same operations as those of the processing units described in the embodiments by reading the information processing program 420A from the HDD 420 and executing the information processing program 420A. Specifically, the information processing program 420A executes the same operations as those of the whole controller 50, the memory amount calculator 51, the recognition controller 70, and the learning controller 71.

The aforementioned information processing program 420A may not be stored in the HDD 420 in an initial state. For example, the information processing program 420A may be stored in a “portable physical medium” such as a flexible disk (FD), a CD-ROM, a DVD, a magneto-optical disc, or an IC card. Then, the computer 400 may read the program from the portable physical medium and execute the program.

In addition, the program may be stored in “another computer (or a server)” connected to the computer 400 via a public line, the Internet, a LAN, or a WAN. Then, the computer 400 may read the program from the other computer and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
set a first memory region in the memory as a region to be used for input to a first intermediate layer of a layered neural network and for output from the first intermediate layer,
set a second memory region in the memory as a buffer region for the first intermediate layer,
execute a recognition process including storing, in the second memory region, characteristic data corresponding to a characteristic of an input neuron data item to the first intermediate layer, and
execute a learning process including determining an error of the first intermediate layer using the characteristic data stored in the second memory region.

2. The information processing apparatus according to claim 1, wherein
the processor is configured to set the second memory region in the memory when a first data size of the input neuron data item is larger than a second data size of a parameter.

3. The information processing apparatus according to claim 1, wherein
a storage capacity of the second memory region is less than a storage capacity of the first memory region.

4. The information processing apparatus according to claim 1, wherein
the characteristic data includes a bit indicating a sign of the input neuron data item.

5. A method of processing data, the method comprising:
setting a first memory region in the memory as a region to be used for input to a first intermediate layer of a layered neural network and for output from the first intermediate layer;
setting a second memory region in the memory as a buffer region for the first intermediate layer;
executing a recognition process including storing, in the second memory region, characteristic data corresponding to a characteristic of an input neuron data item to the first intermediate layer; and
executing a learning process including determining an error of the first intermediate layer using the characteristic data stored in the second memory region.

6. The method according to claim 5, wherein
in the setting of the second memory region, the second memory region in the memory is set when a first data size of the input neuron data item is larger than a second data size of a parameter.

7. The method according to claim 5, wherein
a storage capacity of the second memory region is less than a storage capacity of the first memory region.

8. The method according to claim 5, wherein
the characteristic data includes a bit indicating a sign of the input neuron data item.

9. A non-transitory computer-readable storage medium storing a program that causes an information processing apparatus including a memory and a processor to execute a process, the process comprising:
setting a first memory region in the memory as a region to be used for input to a first intermediate layer of a layered neural network and for output from the first intermediate layer;
setting a second memory region in the memory as a buffer region for the first intermediate layer;
executing a recognition process including storing, in the second memory region, characteristic data corresponding to a characteristic of an input neuron data item to the first intermediate layer; and
executing a learning process including determining an error of the first intermediate layer using the characteristic data stored in the second memory region.

10. The non-transitory computer-readable storage medium according to claim 9, wherein
in the setting of the second memory region, the second memory region in the memory is set when a first data size of the input neuron data item is larger than a second data size of a parameter.

11. The non-transitory computer-readable storage medium according to claim 9, wherein
a storage capacity of the second memory region is less than a storage capacity of the first memory region.

12. The non-transitory computer-readable storage medium according to claim 9, wherein
the characteristic data includes a bit indicating a sign of the input neuron data item.
